(19) United States
(12) Patent Application Publication
(10) Pub. No.: US 2025/0312791 A1
(43) Pub. Date: Oct. 9, 2025

(54) CO-DETECTION AND DIGITAL QUANTIFICATION OF BIOASSAY

(71) Applicant: Zhejiang Dapu Biotechnology Co., Ltd., Jiaxing City (CN)

(72) Inventors: Xiaonan XU, Jiaxing City (CN); Ruyuan SONG, Jiaxing City (CN); Hongbo ZHOU, Jiaxing City (CN)

(21) Appl. No.: 19/241,438

(22) Filed: Jun. 18, 2025

Related U.S. Application Data
(63) Continuation-in-part of application No. 17/266,596, filed on Feb. 7, 2021, now Pat. No. 12,357,989.
(60) Provisional application No. 62/723,455, filed on Aug. 27, 2018.

(51) Int. Cl. B01L 3/00

(52) U.S. Cl. CPC B01L 3/502746; B01L 3/502715; B01L 2400/086

(57) ABSTRACT

The present invention provides methods and devices for detecting and quantifying multiple biomolecules at single-molecule level using an integrated droplet microfluidic system. In one embodiment, the present invention provides real-time and digital measurement of multiple biomolecules in a sample, thereby quantifying multiple biomolecules in an absolute and simultaneous manner. In one embodiment, the present invention provides a diagnostic method for a disease, comprising real-time and digital measurement of multiple biomolecules in a sample using the method or device described herein.

### CROSS REFERENCE TO RELATED APPLICATION

The present application is a continuation-in-part of a co-pending U.S. application Ser. No. 17/266,596, which is a U.S. national stage application of PCT/CN2019/102474, filed on Aug. 26, 2019, which claims priority to U.S. Provisional Patent Application Ser. No. 62/723,455, filed on Aug. 27, 2018. Each of the aforementioned patent application is herein incorporated by reference in its entirety, including all tables, diagrams and claims.

### FIELD OF THE INVENTION

The present invention relates to methods and devices for detecting and quantifying multiple biomolecules at single-molecule level using an integrated droplet microfluidic system.

### BACKGROUND OF THE INVENTION

There are numerous biomarkers present in the human biofluids, such as blood, urine, saliva and seminal plasma. Circulating biomarkers present in blood include cell free DNA (cf DNA), protein, extracellular vesicles and circulating tumor cells. Accurate quantification of biomarkers is significant incorrect and reliable diagnosis, prognosis, and progression monitoring of diseases or conditions, in particular for detection of disease in its early stage or prenatal screening in the form of non-invasive prenatal testing (NIPT). However, at the time of this invention, the only widely used blood test for detection of early-stage prostate cancer is based on the measurement of prostate specific antigen (PSA) marker, and the proper use of this test is still controversial. To measure the quantity of the biomarkers with high sensitivity and specificity is of critical importance to prevent misdiagnosis because otherwise too many healthy individuals will receive false positive test results, leading to unnecessary follow-up procedures and anxiety, while in the other way around, false negative test results may lead to delay in treatment and adversely affect the patients. Also, from the aspect of scientific discovery, accurate quantification of biomarkers is important for understanding the correlation between biomarkers and corresponding disease and establishing a reliable and robust correlation for use as a clinical indicator of the disease.

Numerous efforts have been made in academia and industry to quantify different types of biomarkers. Traditional ways for nucleic acid quantification include analysis of bands of gel electrophoresis of products from polymerase chain reactions (PCR), real time PCR and recently emerging technologies such as next generation sequencing (NGS) and other sequencing methods. For protein quantification, enzyme-linked immunos or bent assay (ELISA) method has been widely used and protein mass spectrometry as recently emerged can also be used. For exosome quantification, nanoparticle tracking analysis (NTA) and ExoELISA™ method are widely adopted.

The methods mentioned above have been widely adopted in laboratories or clinics.

However, these methods cannot provide enough sensitivity for a valid and sensitive diagnosis or are not capable of absolute quantification and therefore are not competent for diagnostic tests that require the biomarkers be quantified with high precision for a valid result. At the time of this invention, most of the traditional diagnostic methods which require quantification of markers utilize bulk volume assay for markers quantification and can only give a qualitative or semi-quantitative result since the molecular information obtained is the average information of thousands of events of the bulk volume assay, thus the detection may not be very precise. On the other hand, new methods based on NGS or mass spectrometry (MS) enable a high throughput and accurate measurement of the markers but are relatively time consuming and expensive to implement. This is especially true when these methods generate a large amount of unnecessary data, complicating the post-data analysis.

Another important concern is that most of the current diagnostic platforms are not able to detect and/or quantify multiple biomarkers of different types such as DNA and protein markers simultaneously. Some diseases may require a co-detection of two or more markers for an accurate diagnosis. For example, clinical research has demonstrated that the maximum sensitivity of plasma DNA-based tests (“liquid biopsies”) was limited to localized cancers. Combined detection of genetic alterations and protein biomarkers may not only help to identify the presence of relatively early cancers but also to localize the organ of origin of these cancers. Accuracy of the detection or diagnosis could be essentially improved since the test requires co-detection of multiple biomarkers and particular correlation among their levels in order to clinically establish the existence of a condition or disease.

In recent years, digital technology such as digital PCR and digital ELISA technology which use microfluidic technology to compartmentalize as ample into thousands of isolated aliquots has emerged. Thousands of PCR or ELISA reactions occur in the individual space without interference, thereby enabling the detection to be reduced to single molecule level and absolute and accurate quantification of biomolecules. It brings the molecular diagnostics to unprecedented accuracy while at the same time preserves the high specificity of the PCR and ELISA assays. However, current digital platforms are limited to end-point detection (i.e., detection after end of reactions) and one single type of reaction and detection (e.g., digital PCR reactions and digital ELISA reactions cannot be integrated into one platform such that PCR reactions and ELISA reactions can be carried out in different droplets). Therefore, these current digital platforms cannot detect multiple biomolecules in a real-time manner.

### SUMMARY OF THE INVENTION

This invention introduces for the first time the concept of using a digital platform in microfluidic setting for co-detecting multiple biomolecules down to single molecule level and quantifying these multiple biomolecules in a real-time manner, thereby allowing an efficient and accurate diagnosis.

The present invention provides methods and devices for detecting and quantifying multiple biomolecules at single-molecule level using an integrated droplet microfluidic system.

In one embodiment, the present invention provides a real-time and digital measurement of multiple biomolecules in a sample, thereby quantifying multiple biomolecules in an absolute and simultaneous manner.

In one embodiment, the present invention provides a diagnostic method for a disease, comprising a real-time and digital measurement of multiple biomolecules in a sample using the method or device described herein.

In one embodiment of the present integrated droplet microfluidic system for digital quantification of bioassay, said system including four parts (from left to right): inlets, a droplet generator, a droplet storage chamber and an outlet. Inlets are used to introduce various liquids (e.g. oil, samples and reagents for carrying out reactions) to the droplet generator, wherein these liquids can be loaded separately through different inlets, or premixed and loaded as a mixture through the same inlet. Sample containing biomolecules is prepared and compartmentalized into isolated droplets through the droplet generator, the droplets generated are then spread in a one-layer configuration in a droplet storage chamber. After sample compartmentalization, parallel in situreactions happen in individual droplets, where the reactions are part of a reaction assay for analyzing the target biomolecules, and the reactions in different droplets can be the same or different. Once the reactions are completed, signals indicating the presence of target biomolecules are detected by, for example, capturing the image of the droplets in the droplet storage chamber by a microscopic camera. The images are then processed by computer for digital counting and data analysis. Outlet is for removal of liquid or gas from the system. In one embodiment, outlet is for air or oil draining. In another embodiment where droplets need to be collected after reactions, they can be collected from the droplet storage chamber through the outlet.

In one embodiment, the present methods and devices comprise an integrated droplet microfluidic system which is capable of generating thousands of droplets, thereby compartmentalizing a sample into thousands of isolated droplets for subsequent reactions and analysis per single droplet.

In one embodiment, the present invention provides an integrated droplet microfluidic system for generating a plurality of isolated droplets from a sample.

In one embodiment, the present integrated droplet microfluidic system is configured as one single microfluidic chip.

In one embodiment, the present microfluidic system is formed by a droplet generator and a droplet storage chamber. In one embodiment, a sample containing biomolecules is compartmentalized into isolated droplets through a droplet generator, the droplets generated are then deposited in the droplet storage chamber in a one-layer configuration.

In one embodiment, the present integrated droplet microfluidic system comprises a plurality of microfluidic channels for delivering fluids to and from various components of the system. In one embodiment, the present droplet generator, droplet storage chamber and/or outlet comprises one or more microfluidic channels which set the flow paths of the fluids within these components. In one embodiment, one or more microfluidic channels are provided between different components of the integrated droplet microfluidic system (e.g. between droplet generator and droplet storage chamber) so as to direct fluid from one component to another component. In one embodiment, the exact type or configuration (e.g. structure, length, diameter, number of branches and density) of the microfluidic channels to be used depends on the purpose of having the microfluidic channels and the desirable flow resistance of individual components.

In one embodiment, the present invention enables real-time and digital measurement of multiple droplets generated from a sample by quantitative and independent measurement of a specific signal in each droplet.

In one embodiment, by utilizing the present integrated droplet microfluidic system coupled with a motion and temperature control system and a detection unit, the present invention is capable of conducting multiplex reactions in thousands of droplets and digital detection of different biomolecules in each of these droplets, thereby obtaining an absolute quantity of the target molecules in a sample for diagnostic or other analytical purposes. Since the measurement is real-time and down to a single molecule, the present invention provides more useful and accurate information than existing methods for end-point digital measurement.

In one embodiment, the present invention provides methods for implementing digital quantification and analysis of a bioassay, comprising four steps: 1) sample preparation, 2) sample compartmentalization, 3) reaction, and 4) digital detection.

In one embodiment, the present invention provides a diagnostic method for a disease, comprising a real-time and digital measurement of multiple biomolecules in a sample using the method or device described herein.

In one embodiment, the present invention provides a droplet microfluidic system, comprising: a droplet generator and a storage device containing a plurality of droplets, wherein each tiny hole of each storage device stores a droplet, wherein the droplet generator and the droplet storage device are integrated structure, wherein the droplet generator is in fluidic communication with the droplet storage device, each of pores being in fluidic communication.

In one embodiment, the droplet generator comprises an inlet and the droplet storage device comprises an outlet. In one embodiment, the droplet generator includes a plurality of inlets, each inlet is used for receiving a different reagent component, and one inlet is used for receiving a sample.

In one embodiment, the droplet generator is in fluidic communication with the droplet storage device via a microfluidic channel. In one embodiment, the material for making the microfluidic channel is selected from one or more of silicon, glass, plastic, and polydimethylsiloxane (PDMS). In one embodiment, the diameter of the microfluidic channel is 1-2 times the diameter of a droplet.

In one embodiment, the droplet generator is a droplet generating device based on surface tension. In one embodiment, the droplet generator comprises a cross-flowing structure that permits the continuous phase and dispersed phase to intersect at a particular angle θ. In one embodiment, the droplet generator comprises a step emulsion structure. In one embodiment, one inlet is used to receive a sample of cells or exosomes and the other one or more inlets are used to receive a lysis reagent or an oily substance when samples are cells or exosomes. In one embodiment, the height of a pore for storing droplets is 1-1.5 times the diameter of the droplets. In one embodiment, the droplet storage chamber comprises rows of anchoring structure for anchoring the droplets to pre-determined positions in the droplet storage chamber. In one embodiment, the anchoring structure takes the form of pillars such as posts arranged in a way that is capable of trapping individual droplets. In one embodiment, the droplet contains no more than one copy or one target molecule to be analysed in subsequent steps.

In another aspect, the present invention aims to solve various problems in droplet sorting, such as the technical obstacles and troubles of the high droplet breakage rate and inability to form one-layer droplets effectively in traditional devices. The present invention improves the structure of droplets in the storage space, which can solve the problem of droplet breakage and ensure the integrity of droplets. Meanwhile, to facilitate the subsequent separation and screening of droplets after passing through the channel, the droplets can quickly form a one-layer arrangement before entering the screening module. The one-layer droplet arrangement allows the droplets to pass through the channel individually and flow into the subsequent screening module.

In some embodiments, the droplet storage space is the space between the droplet inlet and the droplet outlet, and the height of this space is set to gradually decrease from the inlet to the outlet. In this way, before the droplets flow to the outlet, they are arranged in a single layer. In some embodiments, the upstream of the droplet inlet is a component for generating droplets. This component or structure generates droplets, which need to enter, for example, the storage space for arrangement or reorganization, thereby forming a one-layer droplet arrangement.

In some embodiments, the storage space is composed of a storage chamber and a cover plate. The cover plate seals the storage chamber to form a space with an inlet and an outlet. Inside this space, the bottom face formed from the inlet to the outlet is structured as an inclined plane or slope. The height of the space at the droplet inlet is greater than or far greater than the diameter of the droplet, allowing many droplets to be positioned at the inlet. As the droplets flow, the height of the storage space gradually decreases, causing the droplets to be progressively compressed. At the outlet, the height of the storage space is less than or equal to the size of the droplets. Near the outlet, the droplets are flattened or have a height equal to the diameter of the droplet, thus forming a one-layer droplet arrangement at the outlet. The one-layer droplet arrangement can continue to flow into the downstream channel. At the outlet of the channel, droplets are tested for positivity. If positive, a voltage is applied to deflect the droplet into the positive droplet channel; conversely, negative droplets are allowed to enter the negative channel.

Therefore, in some embodiments, the droplet outlet is connected to a channel whose outlet width is smaller than the droplet diameter. In some embodiments, the channel outlet is equipped with a spacer oil channel, which is designed to create spacing between droplets exiting the channel, facilitating subsequent droplet detection, separation, or screening.

In some embodiments, some micropillars are disposed in the storage space with distances therebetween. The purpose of disposing the micropillars is to enable droplets to form an ordered arrangement or disperse as they pass through the distances between the micropillars. In some embodiments, the distance between micropillars near the inlet is greater than that near the droplet outlet. This allows a higher number of droplets to pass through the micropillars near the inlet, while fewer droplets pass through near the outlet, creating a gradual transition that ensures formation of a filled yet one-layer arrangement. Thus, in some embodiments, the storage space is provided with a cluster of first micropillars and a cluster of second micropillars. The cluster of first micropillars is close to the droplet inlet, and the cluster of second micropillars is close to the droplet outlet. In some embodiments, from the vicinity of the droplet inlet to the area away from the droplet inlet, the distance between micropillars in the cluster of first micropillars gradually decreases or shortens. By adopting this approach, the process of droplet dispersion can be gradual, which has significant advantages over traditional micropillars for droplet dispersion, where the distances between micropillars are uniformly distributed and occupy the entire storage space. In some embodiments, an impurity filtration region is disposed downstream of the cluster of first micropillars. In some embodiments, the cluster of second micropillars is positioned near the droplet outlet, with the distance between pillars in this cluster of micropillars smaller than that in the cluster of first micropillars. In some embodiments, this approach not only allows droplets to pass through the storage space but also effectively prevents droplet rupture by gradually reducing the distance between micropillars. For example, the distance between pillars in the cluster of first micropillars is greater than the droplet diameter, allowing two or more droplets to pass through simultaneously. This differs from traditional methods where micropillars are equally spaced and only allow single droplets to pass through, leading to droplet congestion. Additionally, since droplet flow requires pressure to be applied at the inlet, the pressure will inevitably cause droplets to break between the micropillars, thus hindering subsequent effective screening. However, in the present invention, the distance between micropillars in the cluster of micropillars at the droplet inlet is relatively large. When pressure is applied, as droplets move toward the outlet, the force between droplets and the micropillars is effectively reduced, thereby reducing droplet breakage. This is particularly useful for droplets containing rare samples.

In some embodiments, some impurity filtration regions are further disposed within the storage space. These impurity filtration regions primarily filter out dust, short fibers, etc., between droplets to prevent them from entering the downstream droplet outlet. In some embodiments, the filtration region includes intermittently arranged filter blocks, forming flow channels between the blocks that are oriented toward the droplet inlet. In some embodiments, the impurity filtration region includes a first and a second impurity filtration region. The first filtration region is located downstream of the cluster of first micropillars, and the second filtration region is close to the droplet outlet. In some embodiments, the distance between filter blocks in the first filtration region is greater than that in the second filtration region.

In some embodiments, the storage space is provided with support pillars, which mainly support the upper cover to prevent it from collapsing or coming into contact with the bottom of the storage chamber. In some embodiments, the region with support pillars is set upstream of the outlet and downstream of the cluster of second micropillars, forming an empty region upstream of the outlet. The distance between support pillars is sufficiently wide, allowing droplets to be flattened and distributed in a single layer within this region.

In some embodiments, support pillars are also disposed downstream of the first filtration region. In some embodiments, support pillars are also disposed at the droplet inlet. Generally, the distance between support pillars is sufficiently wide, primarily serving to support the upper cover without playing a substantial role in droplet discharge. The substantial role in droplet arrangement is played by the cluster of micropillars. Meanwhile, the storage chamber is of an inclined structure from the inlet to the outlet. The height at the inlet is greater than or far greater than the droplet diameter, while the height at the outlet is smaller than the droplet diameter. This enables formation of droplets of a one-layer arrangement while significantly reducing droplet breakage.

Therefore, the present invention provides a microdroplet arrangement device, including: a microdroplet inlet and a microdroplet outlet, with a droplet storage space disposed between the inlet and the outlet, where a height of the storage space gradually decreases from the inlet to the outlet, thereby achieving a one-layer distribution of droplets.

In some embodiments, the one-layer distribution of the droplets is achieved near the outlet. In some embodiments, a droplet screening assembly is disposed downstream of the outlet to separate or screen target droplets. In some embodiments, within the storage space, a height at the inlet is greater than a diameter of the droplet, and a height near the outlet is less than the diameter of the droplet. In some embodiments, the height at the inlet is more than 1 time, 2 times, 3 times, or 4 times the diameter of the droplet. In some embodiments, the height at the outlet is one-half, one-third, or one-fourth of the diameter of the droplet.

In some embodiments, the storage space includes a cluster of micropillars for dispersing the droplets, where a distance between the dispersing micropillars at the inlet is greater than a distance between the dispersing micropillars at the outlet. In some embodiments, the storage space includes a blocking structure for blocking impurities, and the blocking structure allows the droplets to pass through.

In some embodiments, the storage space includes first and second blocking structures for blocking impurities, and the blocking structures allow the droplets to pass through, where the first blocking structures are close to the inlet, and the second blocking structures are close to the outlet.

In some embodiments, a distance between the first blocking structures is greater than a distance between the second blocking structures.

In some embodiments, the storage space is composed of a recessed bottom and an upper cover, and one or more support pillars are disposed on the recessed bottom to support the upper cover. In some embodiments, the support pillars are disposed at the inlet, at a middle portion of the storage space, or near the outlet. In some embodiments, a droplet generation structure is disposed upstream of the inlet, and the droplet generation structure is selected from the group consisting of a flow focusing structure, a cross-flowing structure, a co-flowing structure, a step emulsion structure, and a microchannel emulsification structure.

In some embodiments, the microdroplets include cells or other active substances.

### BRIEF DESCRIPTION OF DRAWINGS

FIG. 1 shows one embodiment of the present invention for implementing a digital quantification bioassay, comprising four steps: 1) sample preparation, 2) sample compartmentalization, 3) reaction, and 4) digital detection.

FIG. 2 shows one embodiment of the present invention comprising an integrated droplet microfluidic system for digital quantification bioassay.

FIG. 3 shows one embodiment of droplet generation in the present invention.

FIG. 4 shows another embodiment of droplet generation in the present invention.

FIG. 5 shows one embodiment of anchoring structures in the droplet storage chamber. The anchoring structure strap individual droplets to pre-determined positions in the droplet storage chamber.

FIG. 6 shows another embodiment of an anchoring structure in the droplet storage chamber.

FIG. 7 shows one embodiment of a droplet generating device comprising a flow focusing structure coupled downstream with a droplet storage chamber.

FIG. 8 shows a florescence image of droplets obtained by a CCD camera.

FIG. 9 shows one embodiment of the present integrated droplet microfluidic system for digital quantification of RNA from a single exosome.

FIG. 10 shows a process of digital quantification of RNA from a single exosome.

FIG. 11 shows two images of the fluorescent signals obtained from droplets containing amplified DNA molecules in an end-point digital detection of target DNA molecules using the present invention.

FIG. 12 is an exploded three-dimensional structural schematic diagram of a droplet arrangement device of the present invention. The diagram includes a droplet arrangement device, and a droplet sorting device, and may also include a droplet generation device. The three devices are in fluid communication through microchannels, generally with the droplet arrangement device located downstream of the droplet generation device, and the sorting device located downstream of the arrangement device.

FIG. 13 is a three-dimensional planar distribution diagram of each chamber and microchannel 290 on a substrate 10 provided with microchannels.

FIG. 14A is a three-dimensional planar distribution diagram of each chamber and microchannels on the substrate 10.

FIG. 14B is a schematic diagram illustrating a principle of a droplet arrangement space in a specific embodiment of the present invention.

FIG. 14C is a schematic diagram illustrating a principle of a droplet arrangement space in a specific embodiment of the present invention.

FIG. 15 is a schematic structural diagram of a droplet arrangement space in a specific embodiment of the present invention.

FIG. 16 is an enlarged schematic partial structural diagram of a partial droplet arrangement space in a specific embodiment of the present invention.

FIG. 17 is an enlarged schematic partial structural diagram of a partial droplet arrangement space in a specific embodiment of the present invention.

FIG. 18 is a schematic partial structural diagram of a microfluidic channel in a sorting region 161 in a specific embodiment of the present invention.

FIG. 19 is a partial microscopic enlarged view of a specific product of the present invention (white dots represent support pillars and dispersing micropillars in blank regions, as well as impurity filtration regions).

FIG. 20 is a microscopic enlarged view of a droplet 900 entering a channel 18 in a specific product of the present invention.

FIG. 21A is an enlarged micrograph showing a one-layer distribution of droplets in the channel 18 of a specific product of the present invention, where a depth is smaller than a diameter of a droplet, resulting in the droplets being flattened.

FIG. 21B is an enlarged micrograph showing a one-layer distribution of droplets in the channel 18 of a specific product of the present invention, where a depth is smaller than a diameter of a droplet, resulting in the droplets being flattened.

FIG. 21C is an enlarged micrograph showing a state where droplets in a channel outlet 181 of a specific product of the present invention are spaced by spacer oil to form single-droplet flow.

### DETAILED DESCRIPTION OF THE INVENTION

### Definitions and Interpretations

Unless specifically stated otherwise, the words and terms of the present invention are to be explained by common meanings.

### Detection

Detection is to analyze or test the presence of a substance or a material. The substance or material herein, for example, includes but not limited to a chemical substance, an organic compound, an inorganic compound, a metabolite, a drug or a drug metabolite, an organic tissue or a metabolite of an organic tissue, a nucleic acid, a protein or a polymer. In addition, the detection is also to test the amount of a substance or a material, and the assay includes immunoassay, chemical assay, enzyme assay and nucleic acid assay, etc.

The present invention provides methods and devices for detecting and quantifying multiple biomolecules at single-molecule level using an integrated droplet microfluidic system.

In one embodiment, the present methods and devices comprise an integrated droplet microfluidic system which is capable of generating thousands of droplets, thereby compartmentalizing a sample into thousands of isolated droplets for subsequent reactions and analysis per single droplet.

In one embodiment, the present invention enables real-time and digital measurement of multiple droplets generated from a sample by quantitative and independent measurement of a specific signal in each droplet.

In one embodiment, the present invention provides a diagnostic method for a disease, comprising real-time and digital measurement of multiple biomolecules in a sample using the method or device described herein.

As illustrated herein, the present invention introduces for the first time the concept of using a digital platform in microfluidic setting for co-detecting multiple biomolecules down to single-molecule level and quantifying these multiple biomolecules in a real-time manner, thereby allowing an efficient and accurate diagnosis.

By utilizing the present integrated droplet microfluidic system coupled with a motion and temperature control system and a detection unit, the present invention is capable of conducting multiplex reactions in thousands of droplets and digital detection of different biomolecules in each of these droplets, thereby obtaining an absolute quantity of the target molecules in a sample for diagnostic or other analytical purposes. Since the measurement is real-time and down to a single molecule, the present invention provides more useful and accurate information than existing methods for end-point digital measurement.

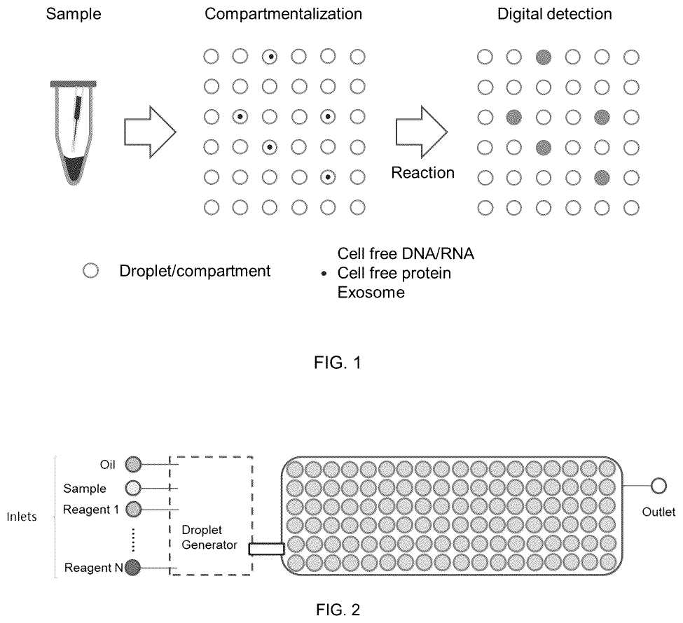

In one embodiment, the present invention provides methods and devices for implementing digital quantification and analysis of a bioassay, comprising four steps: 1) sample preparation, 2) sample compartmentalization, 3) reaction, and 4) digital detection as illustrated in FIG. 1.

FIG. 2 illustrates one embodiment of the present integrated droplet microfluidic system for digital quantification of bioassay, said system including four parts (from left to right): inlets, a droplet generator, a droplet storage chamber and an outlet. Inlets are used to introduce various liquids (e.g. oil, samples and reagents for carrying out reactions) to the droplet generator, wherein these liquids can be loaded separately through different inlets (as instantly shown in FIG. 2), or premixed and loaded as a mixture through the same inlet. Sample containing biomolecules is prepared and compartmentalized into isolated droplets through the droplet generator, the droplets generated are then spread in a one-layer configuration in a droplet storage chamber. After sample compartmentalization, parallel in situ reactions happen in individual droplets, where the reactions are part of a reaction assay for analyzing the target biomolecules, and the reactions in different droplets can be the same or different. Once the reactions are completed, signals indicating the presence of target biomolecules are detected by, for example, capturing the image of the droplets in the droplet storage chamber by a microscopic camera. The images are then processed by computer for digital counting and data analysis. Outlet is for removal of liquid or gas from the system. In one embodiment, outlet is for air or oil draining. In another embodiment where droplets need to be collected after reactions, they can be collected from the droplet storage chamber through the outlet.

### Sample Preparation

The present invention can be applied to any type of samples containing target biomolecules. In one embodiment, the sample is a liquid sample obtained directly from a living organism including but not limited to human, animal, plant, fungi, microorganism such as bacterium and virus. In one embodiment, the sample is a solution containing the target biomolecules, wherein the solution can be obtained from another independent process that handles the target biomolecules. For example, the independent process is a process that isolates, purifies or concentrates the target biomolecules in a sample containing the target biomolecules, or a pre-treatment process that pre-treats a sample containing the target biomolecules with certain enzymes or reagents, under certain temperature or pressure.

Samples herein may include biological fluids. The initial state of samples or specimens may be liquid, solid or semi-solid. The solid or semi-solid samples may be converted to liquid samples by any suitable methods, such as mixing, mashing, maceration, incubation, dissolution, enzymatic hydrolysis, etc. Then the samples undergo digitalization processing i.e. droplet generation. During and before the digitalization processing i.e. droplet generation, samples may be treated, including filtration, dissolution, etc., or mixing with other reagents, to improve some performance of the samples and facilitate to provide better results in forming tiny droplets or detecting subsequently. Samples can be taken from humans, animals, plants, nature, etc. Samples taken from human body may be, for example, liquid samples, including blood, serum, urine, cerebrospinal fluid, sweat, lymph, saliva, gastric juice, etc.; solid or semi-solid samples including feces, hair, keratin, tartar, nails, etc. Samples taken from plants may be, for example, solid samples including roots, stems, leaves, etc., liquid or semi-solid samples including tissue fluid, cell fluid prepared from roots, stems, and leaves. Samples taken from nature may be, for example, liquid samples including rainwater, river water, seawater, and groundwater, etc., solid or semi-solid samples including soil, rock, ore, and petroleum, etc.

In one embodiment, samples include but are not limited to blood, plasma, serum, tissues, urine, saliva, fecal matters, smear preparations, and discharges such as tears, sputum, nasopharyngeal mucus, vaginal discharge and penile discharge. In one embodiment, samples include but are not limited to bacteria, viruses, bacteria cultures, viral cultures, cell cultures, cell suspensions, and adherent cells. In another embodiment, samples include but are not limited to food, feed, and plant.

In one embodiment, samples are taken directly from a subject. In one embodiment, samples are those which contain one or more biomolecules from a subject, including immediate or final products obtainable from various molecular assays such as polymerase chain reaction (PCR).

In one embodiment, the present invention comprises a step of providing or preparing a sample containing a target biomolecule to be detected or quantified by the present invention.

These target molecules or analytes are of different types. Different types of analytes are present in the same sample, for example, different biomolecules or different biomarkers. For example, in a cell, nucleic acids, proteins, polysaccharides, small molecule peptides are present. These different labeled substances or analytes are different. In the present invention, a base substance is provided, for example, on a microfluid chip, to carry out detection of different types of analytes simultaneously, such as simultaneous detection of nucleic acids and proteins, simultaneous detection of nucleic acids and proteins associated with a disease, for example, nucleic acid mutations and protein molecule levels of a cancer or tumor. Here, the different types can also mean the same classification, but may have different meanings. For example, for detection of nucleic acids, DNA levels and RNA levels can be detected simultaneously. Here, the DNA levels and RNA levels can be considered different types of detection. For example, for protein levels, biologically labeled substances of different proteins can also be considered as different types of detection. For example, a plurality of protein molecules is associated with a disease, and these protein molecules have different polypeptide sequences, different protein three-dimensional structures, one or more of different sites, although they belong to the protein levels, the protein markers are different. The detection device or detection method of the present invention can also be used to simultaneously detect different types of protein molecules. For a specific disease, the contents of a variety of substances are provided and these substances are from the same sample, by this way, it reduces the number of times of sampling or reduce the amount of sample, and a variety of test results can be provided, for example, diagnosis of a disease.

In one embodiment, the size of a sample is 1 μL-500 μL. Too large of a sample volume may take a long time for droplet generation. Too small of a sample volume may lead to difficulty in loading the sample to the droplet generator.

In one embodiment, the viscosity of a sample is not larger than 0.5 Ns/m². In one embodiment, the sample does not contain solvent components which may cause droplets to merge such as DMSO.

### Integrated Droplet Microfluidic System

In some specific embodiments, the present invention provides an integrated detection system or detection device, comprising a droplet generating device and a droplet storage device. The “integrated” herein means that the two components are connected into a single structure and form a whole structure, which can perform different functions at the same time, but these functions are carried out in a sequence and are integrated, to reduce the non-integrated operation steps. For example, in prior art, when a microfluidic system is used for detection, the liquid is generated by a separate droplet generation system, and when droplets are generated, another device is used to store the droplets, and usually a number of droplets are stored together. When reaction is necessary, the reaction is directly carried out in a storage container or it is transferred to a separate reaction device for reaction, such as incubation, heat cycling and amplification, etc. After the reaction is completed, the plurality of droplets are required to be separated for detection, for example, by a flow cytometer. The test results are read for droplets one by one. With many steps, the operation is cumbersome, which may also produce uncertainty to the final test results. For example, as there are many operation steps, different personnel may operate different batches, and increase the risk factors that affect the final test results; for example, frequent transfer of droplets will cause loss or fusion of droplets; for example, when mixing multiple droplets together for reaction, special attention should be paid to the control of incubation temperature because of the problem of uneven heat transfer; for example, multi-step transfer may cause cross-contamination and produce false positive results, affecting the accuracy of the experiment, which is particularly important in clinical tests. In the present invention, the functional components for forming droplets are combined with the reaction and detection, and only the samples are needed to prepare, and then all steps can be completed by one step, which greatly simplifies the operation steps, and reduces the adverse effect of different steps on the final detection.

Accordingly, in a specific embodiment, the present invention provides a detection system comprising a liquid generation system and a storage system. The storage system is used to store the droplets generated from liquid. In some embodiments, the droplet generating system is capable of generating a plurality of individual tiny droplets. The storage system includes a plurality of storage units, such as storage holes and cavities, each of which has a droplet stored therein. In some embodiments, the droplet generating system is in fluidic communication with the storage system via the microfluidic channel. The storage system herein includes a liquid inlet and an outlet, and there are a plurality of storage holes, chambers and cavities between the inlet and the outlet. It can be understood that the storage system herein can be directly used to perform a certain reaction. For example, the system in FIG. 2, includes a storage system (on the right side of FIG. 2), and the storage system includes a plurality of microporous structures, and each of which has a droplet stored therein. When these liquids include substances necessary for the reaction, for example, when performing nucleic acid amplification, there are primers and enzymes for amplification, etc., which can be directly given to the storage system for reaction. At this time, the storage system is a reaction container. The contain comprises a plurality of individual holes, and each hole has a separate droplet, and a separate reaction occurs in each droplet, and each droplet has a final result of independent reaction. When reaction ends, the reaction results can be detected for the storage system directly, and results of multiple independent reactions (multiple independent droplets) can be detected at one time. Compared to conventional multi-step testing, it is easy to operate for multiple different or identical test results.

Therefore, for generation of individual droplets, simultaneous detection of different types of analytes can be performed, for example, detection of nucleic acids and proteins, as described in detail later.

FIG. 2 illustrates one embodiment of the present integrated droplet microfluidic system for digital quantification of bioassay, comprising inlets, a droplet generator, a droplet storage chamber and an outlet

In one embodiment, the present invention provides an integrated droplet microfluidic system for generating a plurality of isolated droplets from a sample.

In one embodiment, the present integrated droplet microfluidic system is configured as one single microfluidic chip.

In one embodiment, the present microfluidic system is formed by a droplet generator and a droplet storage chamber. In one embodiment, a sample containing biomolecules is compartmentalized into isolated droplets through a droplet generator, the droplets generated are then deposited in the droplet storage chamber in a one-layer configuration.

Inlets are used to introduce various liquids (e.g. oil, samples and reagents for carrying out reactions) into a droplet generator. As illustrated in FIG. 2, oil, sample and reagents 1 to N (i.e., various reagents required for subsequent reactions) are introduced into the droplet generator via different inlets. In one embodiment where the sample and reagents do not have chemical reactions, they can be premixed and loaded into the droplet generator as a mixture through one inlet. In another embodiment where the sample and one or more of the reagents react, these reagents and sample cannot be introduced into the droplet generator as a mixture but loaded into the droplet generator through different inlets and then compartmentalized into droplets at the junction of the droplet generator.

For example, where digital PCR for quantifying DNA through hot start amplification is to be carried out in a droplet, a sample containing the target nucleic acids and reagents for carrying out hot start amplification including primers, polymerases and other buffers can be premixed and loaded into the same inlet for droplet generation since reaction will only be started by raising the temperature to the working temperature of the polymerases. However, if enzymes in the reagents catalyse any substrate in the sample at room temperature, the enzyme-containing reagents and sample need to be loaded into the droplet generator through different inlets and then mixed within each droplet at the junction of the droplet generator.

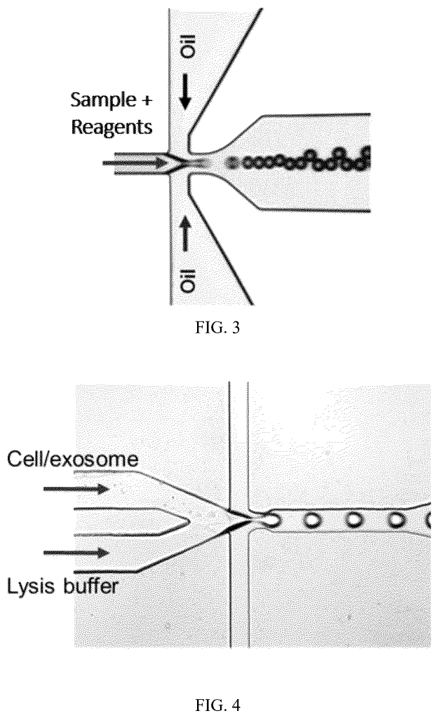

FIG. 3 and FIG. 4 show two embodiments of droplet generation using the present invention. In FIG. 3, the original sample and reagents for carrying out subsequent reactions are premixed and the resulting mixture is subject to the droplet generator for encapsulation. In FIG. 4, since pre-mixing of cells or exosomes and the lysis buffer will lead to lysis of the cells or exosomes, the original sample containing cells or exosomes and lysis buffer are loaded into the droplet generator via different inlets, such that they cannot be brought into contact before they are encapsulated into the droplets. In FIG. 4, since pre-mixing of cells or exosomes and the lysis buffer will lead to lysis of the cells or exosomes and inability to observe the expression at the single cell level, the original sample containing cells or exosomes and lysis buffer are loaded into the droplet generator via different inlets, such that they cannot be brought into contact before they are encapsulated into the droplets.

Droplet generators of the present invention can be of any structure or system that is capable of partitioning a liquid sample into a large quantity of droplets. In one embodiment, droplet generators include but are not limited to structures of flow focusing, T-junction and step emulsion.

Droplet storage chamber of the present invention can be any module that is capable of holding droplets generated by the droplet generators. In one embodiment, the design of the present droplet storage chamber depends on the total number and volume of droplets desired for specific assays.

In one embodiment, the droplets generated are spread in the droplet storage chamber in a one-layer configuration. After sample compartmentalization, parallel reactions are carried out in individual droplet in the droplet storage chamber, followed by detection and analysis of the target biomolecules.

In one embodiment, outlet is used to remove liquid or gas from the present integrated system. In one embodiment, outlet is for air or oil draining. In another embodiment where droplets need to be collected after reactions, they can be collected from the droplet storage chamber via the outlet.

In one embodiment, the present integrated droplet microfluidic system further comprises a unit for sorting and separation of droplets. For example, a sorting junction comprising electrodes in an alternating current (AC) electric field can be included in the present integrated droplet microfluidic system to select particular droplets which, for example, contain a particular type of target molecules or have particular properties as indicated by fluorescent signals observed from the droplets (Baret, Jean-Christophe, 2009).

In one embodiment, the present integrated droplet microfluidic system comprises a plurality of microfluidic channels for delivering fluids to and from various components of the system. In one embodiment, the present droplet generator, droplet storage chamber and/or outlet comprises one or more microfluidic channels which set the flow paths of the fluids within these components. In one embodiment, one or more microfluidic channels are provided between different components of the integrated droplet microfluidic system (e.g. between droplet generator and droplet storage chamber) so as to direct fluid from one component to another component. In one embodiment, the exact type or configuration (e.g. structure, length, diameter, number of branches and density) of the microfluidic channels to be used depends on the purpose of having the microfluidic channels and the desirable flow resistance of individual components.

In one embodiment, microfluidic channels are made of materials selected from the group consisting of silicon, glass, plastics and polydimethylsiloxane (PDMS).

In one embodiment, the same type or configuration of microfluidic channels is used in various components of the present integrated droplet microfluidic system. In another embodiment, various types or configurations of microfluidic channels are used in various components of the present integrated droplet microfluidic system.

In one embodiment, the present droplet generator comprises two microfluidic channels for delivering oil and one or more microfluidic channels for delivering sample fluid and/or reagents. In one embodiment, the actual configuration depends on the type of emulsion chosen and the number of inlets required.

In one embodiment, a microfluidic channel is used to connect the droplet generator with the droplet storage chamber. In one embodiment, the microfluidic channel has a diameter 1-2 times the diameter of a droplet. Generally, a larger diameter of the microfluidic channel helps to stabilize the droplets as they pass through the channels, and constricting the fluid flow within the channel will also help to stabilize the droplets.

In one embodiment, the droplet storage chamber does not have any microfluidic channel and droplets generated will self-assemble to spread on the flat surface of the chamber. In cases where wells are present in the droplet storage chamber, droplets will be spread in the chamber and then guided into the wells by interfacial tension.

In one embodiment, the present outlet comprises a microfluidic channel which has a diameter of up to several hundred micrometers.

In one embodiment, the microfluidic channels are rectangular in shape (i.e., have a rectangular cross-section). In another embodiment, the microfluidic channels have a round cross-section.

### Compartmentalization—Droplets Generation and Storage

In one embodiment, the present invention provides a droplet generation device capable of producing thousands of droplets, which then discretizes a cell-containing sample into thousands of individual droplets, each droplet containing a single cell or a single membrane-bound organelle. In one embodiment, the droplet generation device is a microfluidic platform capable of generating and discretizing a droplet sample into a large number of individual droplets. In some implementations, the droplet arrangement device of the present invention includes a droplet generation device, and the droplet generation device is in communication with the arrangement device via a microchannel. For example, droplets generated by the droplet generation device flow into a droplet inlet 123 through the microchannel to enter an arrangement space 12 of the arrangement device.

In one embodiment, the present invention comprises a droplet generator which can be any structure or system that is capable of partitioning a liquid sample into a large number of droplets (e.g. thousands or millions of droplets). In one embodiment, droplet generators include but are not limited to structures of flow focusing, crossflowing, co-flowing, step emulsion and microchannel emulsification. P. Zhu and L. Wang (2017) describe a few technologies for droplet generations, the contents of which are hereby incorporated by reference in their entirely.

In one embodiment, the present droplet generator is a shear based droplet based droplet generating device which utilizes shear stress to pinch the fluid thread into small droplets. In one embodiment, shear based droplet based droplet generating devices include but are not limited to devices comprising a cross-flowing structure, a co-flowing structure and a flow focusing structure.

In one embodiment, the present droplet generator is an interfacial tension-based droplet generating device wherein interfacial tension is the dominant driving force in the process of droplet breakup. In one embodiment, interfacial tension-based droplet generating devices include but are not limited to devices comprising a structure of T-junction combining with step emulsion and a microchannel emulsification structure.

In one embodiment, the present droplet generator comprises a droplet generating structure described in WO2016189383A1, the contents of which are hereby incorporated by reference in their entirely into this application.

In one embodiment, methods that are capable of generating droplets can be utilized in the present invention for droplet generation, including but are not limited to high-shear stirring, ultrasonic emulsification, high-pressure homogenization and membrane emulsification.

In one embodiment, the present droplet generator comprises a flow focusing structure which constricts the flow to strength the focusing effect. In one embodiment, the flow focusing structure is a 2D planar flow focusing structure. FIG. 4 shows one embodiment of a droplet generating device comprising a flow focusing structure and a droplet storage chamber coupled downstream of the droplet generator. In FIG. 4, the sample at the center channel is sheared by fluid from side channels and breaks up into small droplets which are then sucked into the droplet storage chamber due to capillary force.

In one embodiment, the present droplet generator comprises a crossflowing structure which permits the continuous phase and dispersed phase to intersect at a certain angle θ. In one embodiment, the present droplet generator comprises a structure of T-junction, Y-junction, double T-junction, K-junction or V-junction.

In one embodiment, the present droplet generator comprises a co-flowing structure in which the dispersed fluid thread is punched off by the surrounding flow continuous phase. In one embodiment, the co-flowing structure is a 2D planar co-flowing structure.

In one embodiment, the present droplet generator comprises a step emulsion structure. In one embodiment, the present droplet generator comprises a step emulsion structure combined with a T-junction structure which is horizontal or vertical

In one embodiment, the present droplet generator comprises a microchannel emulsification structure.

In one embodiment, the present droplet generator comprises a droplet generating structure described in WO2016189383A1, the contents of which are hereby incorporated by reference in their entirely into this application.

In one embodiment, components or parts of the droplet generator which is responsible for droplet generation (i.e. sample compartmentalization) have a hydrophobic surface. It can be accomplished by chemical surface coating by conjugating hydrophobic groups on the surface of the components or parts. In one embodiment, a surfactant such as Span 80, Tween 20 or Abil EM90 is added to the oil phase or water phase to avoid droplet coalescence or prevent molecules such as enzymes, DNA or RNA from adhering to the solid surface or water-oil interface.

In one embodiment, droplets are generated as emulsion droplets and are not limited to a particular type of emulsion. In one embodiment, emulsions include but are not limited to oil-in-water, water-in-oil and water-oil-water double emulsion.

In one embodiment, oil and surfactant are used for droplet generation. In one embodiment, the ratio of surfactant to oil is 1-5% (by weight). In one embodiment, oil to be used for droplet generations includes but is not limited to mineral oil, silicon oil, fluorinated oil, hexadecane and vegetable oil. In one embodiment, surfactant to be used includes but is not limited to Span 80, Tween 20/80, ABIL EM 90 and phospholipids. Surfactants that can be used in droplet-based microfluidics have been described by Baret, Jean-Christophe (2012), the content of which is hereby incorporated by reference in its entirety into this application.

Droplet storage chambers of the present invention can be any module that is capable of holding or preserving droplets, including but not limited to droplets that are generated by the droplet generators. In one embodiment, the design of the present droplet storage chamber depends on the total number and volume of droplets desired for reactions or assays to be performed in the subsequent steps.

In one embodiment, the size of the present droplet storage chamber is larger than the total volume of droplets generated. In one embodiment, the height of the present droplet storage chamber is 1-1.5 times the diameter of the droplets generated. As illustrated in FIG. 3, the height of the droplet storage chamber is 1-1.5 times the droplet diameter; the droplets are spread in the droplet storage chamber in a one-layer configuration.

In one embodiment, the present droplet storage chamber is coupled with the present droplet generator in a way that droplets generated are sucked into the droplet storage chamber by capillary force. In one embodiment, droplets are dispersed in the droplet storage chamber such that the droplets are packed in a specified manner. In one embodiment, droplets are dispersed in the droplet storage chamber such that the droplets are loosely or randomly packed.

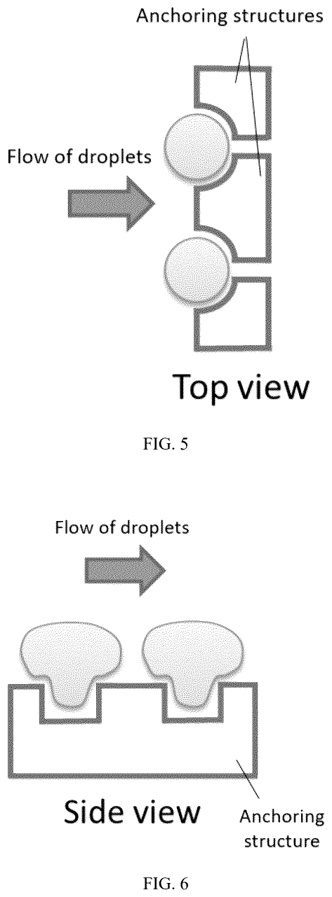

In one embodiment where droplets are dispersed in a specific or pre-determined manner, the droplet storage chamber comprises rows of anchoring structure for anchoring the droplets to pre-determined positions in the droplet storage chamber. In one embodiment, the anchoring structure takes the form of pillars such as posts arranged in a way that is capable of trapping individual droplets (FIG. 5). As the droplets travel through the droplet storage chamber, they will be trapped in space between the pillars. In one embodiment, the anchoring structure takes the form of grooves which trap individual droplets by interfacial tension (FIG. 6). In one embodiment, the present droplet storage chamber comprises anchoring structures or equivalents described in the art, such as those described in Abbyad (2010) and Huebner (2008), the contents of which are hereby incorporated by reference in their entireties into this application.

In one embodiment wherein droplets are randomly packed, no anchoring structures are provided in the droplet storage chamber.

### Droplet Characteristics

In one embodiment, the quantity, size (i.e., diameter), volume and type of emulsion of droplets generated or used by the present invention depend on the subsequent processing or analysis required.

In one embodiment, the number of droplets generated ranges from several hundreds to several millions.

In one embodiment, the size of the droplets generated ranges from about 5 μm to about 200 μm.

In one embodiment, the volume of the droplets generated ranges from about 0.65 fL (femtoliter) to about 4 nL (nanoliter).

In one embodiment, droplets generated are of uniform diameter. In one embodiment, droplets generated have a uniform diameter with coefficient of variation less than 5%. In another embodiment, droplets of varying diameters are generated by adjusting the loading pressure.

In general, droplets to be processed or analysed in one particular assay simultaneously in a droplet storage chamber (or an equivalent platform) are fairly uniform in size and volume to minimise influence on the results due to differences in droplet size or volume.

In one embodiment, each droplet produced by this invention contains no more than one copy of the target molecule (e.g. cell, exosome, or a certain type of biomolecule) to be analysed in subsequent steps. In one embodiment, the number of droplets to be produced and the volume of sample introduced for droplet generations are adjusted in a manner such that each produced droplet would contain no more than one target molecule. Digital methods which distribute target molecules into a large number of droplets theoretically follow the principle of Poisson distribution (Majumdar, 2015). Quantification of target molecules can then be done by counting the droplets which contain one or more copies of the target molecule. To achieve an absolute quantification, each droplet should contain no more than one copy of the target molecule. Generally, according to the principle of Poisson distribution, over 99% of droplets will contain no more than one copy of the target molecule if the ratio of the number of droplets to the number of target molecule is larger than 10, while the percentage will be 96% if the ratio is about 3. For example, when using the present invention for digital quantification of exosome, 10 times more antibody-conjugated beads than the expected number of exosomes is used to ensure that each bead will capture no more than one target exosome for an absolute quantification. Alternatively, in case a single copy of target molecule per droplet is not guaranteed (i.e., some of the droplets may contain more than one copy of the target molecule), Possion statistics are employed to calculate the absolute number of the target molecule (Majumdar, 2015).

The term “copy” as used in the present invention does not merely mean a copy of a nucleic acid in a usual sense, but refers to the number of target molecules, for example, one protein molecule in one sample can be a copy, and one nucleic acid molecule can be a copy of nucleic acid, a polypeptide chain molecule can be a copy of a polypeptide, so the copy herein may be a unit quantifier or a unit that can be quantified by number. Alternatively, a cell can also be called a copy of a cell, actually meaning a cell. When there are two cells, it can be called two copies of cells, although each cell is different, it only refers to two cells, only representing the quantity. Therefore, when a copy is used to measure a particular labeled substance or analyte (nucleic acid, DNA, RAN), it only indicates the number of labeled substances but not indicate whether the labeled substances or the target molecules are of the same type of substances. For example, 1 copy of DAN, RNA only indicates the number of DNA present, and when referring to 2 copies of DNA, it does not mean that two DNAs belong to the same DNA, which may be the same or different. For example, one of the samples is the DNA of A virus, and the other is the DNA of B virus. At this time, we can call 2 copies of DNA. For example, one droplet contains one copy of DNA of A virus, or contains two copies of virus DNA. At this time, two copies of virus DNA may be two DNA of A virus, or two DNA of B virus, or one DNA of A virus and one DNA of B virus.

In one embodiment, the present droplet generator is capable of achieving a high dynamic range by generating droplets of size and quantity that are sufficient for an accurate quantification of the target molecules in the sample. Generally, for digital analytical techniques which employ partitions (e.g. droplets) for detecting target molecules, the dynamic range of detection (i.e., the range of the number of target molecule that can be detected accurately using digital analytical technique) is determined by two main parameters: the size and total number of droplets, which are limited by the partitioning capability of the droplet generating device. For example, it was reported that the dynamic range of typical digital PCR is 0-10⁶, meaning that typical dPCR is unable to determine the absolute count of a target nucleic acid molecule in the sample if the level of that target nucleic acid molecule exceeds the limit of 10⁶ copies/μL. From statistics, having 3-10 times more droplets than target molecules will have a higher accuracy in detection but a smaller dynamic range. On the other hand, a larger dynamic range can be achieved by utilizing the Poisson distribution (Majumdar, 2015).

### Multiplex Reactions in Multiple Droplets

As illustrated herein, the present invention provides a platform for carrying out multiplex reactions in all droplets and a real-time detection and quantification of target molecules in each of these droplets. Different from the end-point measurement in existing droplet-based technologies, this approach can provide a more efficient and accurate diagnosis.

In one embodiment, the present method comprises a step of carrying out multiplex reactions in the droplets generated by the integrated droplet microfluidic system.

In one embodiment, the present invention permits same type or different type of assays to be concurrently carried out in different droplets in a massive parallel manner.

In one embodiment, the same platform is used for droplet storage, for carrying out subsequent reactions or assays, and for detecting target molecules. For example, reactions can be carried out when droplets are dispersed in the present droplet storage chambers. In another embodiment, the platform for carrying out subsequent reactions or assays, and the platform for detecting target molecules are different. For example, when the method requires detection of DNA, the present invention uses a droplet generator for droplet generation, a PCR tube to store the droplets which are then subject to a PCR thermal cycler for reaction, and finally a droplet reader to detect the target molecule and produce a fluorescent signal readout.

Of course, the storage and reaction of droplets can be carried out in the same storage device. For example, if the storage device is in the form of a microfluidic chip, the amplification reaction is carried out in the same storage chip, and then the results of chip reaction are detected.

In one embodiment, after partitioning a sample into numerous isolated droplets and spreading the droplets in a droplet storage chamber, the present method and device carry out one reaction, of the same or different type, in every droplet in the droplet storage chamber concurrently. The present invention permits reaction in one droplet to be carried out independent of any other reactions in other droplets, therefore providing a high flexibility in conducting bioassay of any kind.

The term “reaction” as used herein refers to a reaction of a single droplet; specifically, the substance necessary for the reaction in the droplets can indicate the presence or absence of one or more target molecules. For example, when there are multiple droplets, the reaction of each droplet is different, and the target molecule is also different. For example, one droplet per forms nucleic acid test, the other droplet performs antibody antigen reaction, and other droplets have chemical color reaction. Of course, it is also considered that the DNA amplification reactions of class A specific DNA fragments exist in some individual droplets, and DNA amplification reactions of class B specific DNA fragments exist in some individual droplets, or different RNA reactions exist in different droplets. For example, messenger RNA amplification is performed in one droplet and transcription of RNA is performed in another droplet. By this way, individual reactions can be performed in individual droplets, to achieve the testing of different target molecules.

In one embodiment, reactions to be carried out after the compartmentalization are reactions that target the target biomolecules such that the target biomolecules can be detected or quantified in subsequent steps. In one embodiment, the reactions are any compatible bioassays used in the art. In one embodiment, reactions to be carried out are chosen depending on the nature of the target biomolecules.

In one embodiment, the biomoleculeis a nucleic acid, a protein or a small molecule.

In one embodiment, the biomolecule is a cell-free molecule including but not limited to a cell-free DNA (cfDNA), a cell-free protein, an exosome and a cell-free molecule circulating in the body fluid of a subject. In one embodiment, the biomolecule is a molecule attached to the surface of a cell or inside a cell.

In one embodiment, the biomoleculeis a nucleic acid of various types (e.g. DNA including cDNA, RNA including mRNA and rRNA), forms (e.g. single-stranded, double-stranded, coiled, as a plasmid, non-coding or coding) and lengths (e.g. an oligonucleotide, a gene, a chromosome and genomic DNA), originated from a subject or an exogenous source.

In one embodiment, the biomolecule is a protein which is a peptide or a polypeptide, including an intact protein molecule, a degraded protein molecule and digested fragments of a protein molecule. In one embodiment, biomolecules include but are not limited to antigens, receptors and antibodies, originated from a subject or an exogenous source.

In one embodiment, the biomolecule is a small molecule such as a metabolite. In one embodiment, the metabolite is a disease-related metabolite which is indicative of the presence or extent of a disease or a health condition. In one embodiment, the metabolite is a drug-related metabolite such as a drug by-product of which the level changes in a subject after consuming the drug.

In one embodiment, the target biomolecule is a molecule produced by a tumour or cancer, or by the body of a subject in response to a tumour or cancer.

In one embodiment, the target biomolecule is not normally found in healthy subject. In one embodiment, the target biomolecule is a molecule that is normally found in a healthy subject but the level of which is indicative of a particular disease or a health condition.

For example, biomolecules that are nucleic acids may require amplification by polymerase chain reaction (PCR) and labelling by complementary probes, while biomolecules that are proteins may require hybridization using antibody that recognizes certain epitopes of the proteins.

In one embodiment, where nucleic acids are to be detected and quantified, reactions include but are not limited to polymerase chain reaction (PCR), reverse transcription-PCR (RT-PCR), real-time PCR, and real-time RT-PCR, reverse transcription, labeling, digestion, blotting procedures, enzyme-linked immunosorbent assay (ELISA), radioimmunoassay (RIA), immunoassays and enzymatic assays. For example, ddPCR™ EGFR Exon 19 Deletions Screening Kit (Bio-Rad Laboratories, Inc.) is used to screen for mutations of 15 deletions in Exon 19 of the EGFR gene. Other deletions in this region of the EGFR Exon 19 may also be detected by this kit. EGFR Exon 19 deletions are commonly associated with melanoma, colorectal, and lung cancers.

In one embodiment, where biomolecules of protein nature (e.g. protein, peptide, antibody) are to be detected and quantified, reactions include but are not limited to ELISA-based reactions, labeling of target protein by target-specific signaling moiety and reactions that are catalyzed or inhibited by the target protein. For example, Alpha-Synuclein Discovery Kit (Quanterix™) can be used to detect the presence of Alpha-Synuclein (α-Synuclein) which has a propensity to form toxic soluble oligomers (i.e., protofibrils) that ultimately aggregate into insoluble fibrils. α-Synuclein was reported to be linked to the pathogenesis of Parkinson's disease, dementia of Parkinson's disease, dementia with Lewy bodies, and possibly Alzheimer's disease.

In one embodiment, where exosomes are to be detected and quantified, reactions include but are not limited to reactions for labeling, detecting or quantifying exosome-specific biomolecules. For example, by quantifying exosomes with target Glypican (GPC-1), an exosomal membrane protein which has much higher expression on cancerous exosomes than noncancerous exosomes, from a variety of exosome subpopulation protein biomarkers, is able to differentiate serum samples from breast cancer patients and healthy persons (Liu, 2018). In one embodiment, absolute count of exosomes carrying one or more specific biomolecules can be determined digitally using ExoELISA method. In one embodiment, the method used is the method described in Liu (2018), the content of which is hereby incorporated by reference in its entirety into this application.

In one embodiment, instead of detecting and quantifying the exosomes in a sample, target molecules (and optionally with non-target molecules) are extracted from the exosomes and subsequently detected and quantified by the present invention (Chen, 2013; Li 2018). Yet in another embodiment, both the exosomes and target molecules are detected and quantified using the present methods including but not limited to that described in Example 2. One skilled in the art will be able to choose the appropriate analytical approach for a particular disease or purpose in view of the present disclosure and knowledge in the art.

In one embodiment, when pathogens are to be detected and quantified, reactions include but are not limited to reactions for labeling, detecting or quantifying pathogen-specific biomolecules such as DNA, RNA or viral/bacterial antigen. For example, human immunodeficiency virus (HIV) can be detected and quantified by quantifying its DNA using appropriate kits and droplet digital PCR. It is believed that DNA of HIV provides the most sensitive measurement of residual infection in patients on combination antiretroviral therapy (cART) (Strain, 2013).

In one embodiment, reactions are carried out in each of the droplets generated.

In one embodiment, reactions to be carried out in each of the droplets are of the same type. In another embodiment, reactions to be carried out in each of the droplets are of different types. In yet another embodiment, reactions to be carried out in some of the droplets are of the same type, while reactions to be carried out other droplets are of different types.

In one embodiment, operating conditions (e.g. temperature, pressure and duration) for carrying out the reactions in each of the droplets are the same. In one embodiment, one or more operating conditions for carrying out the reactions in each of the droplets are different.

In one embodiment, target-specific compositions are included in the reactions so as to recognize and label target biomolecules in the droplets. In one embodiment, target-specific compositions are molecules that can specifically recognize a target biomolecule by means of structural recognition, functional recognition, or both.

In one embodiment, target-specific compositions are used to identify and label a specific type or species of biomolecule in the droplets. In one embodiment, target-specific compositions are primers or probes comprising nucleic acids that contain sequence complementary to the target nucleic acids. In one embodiment, target-specific compositions are probes, antibodies or equivalents that recognize specific epitopes or spatial configurations possessed by a target biomolecule such as a protein, peptide and viral particle.

In one embodiment, target-specific compositions are molecules that can be processed (e.g. digested, reduced, oxidized, or otherwise modified) by the target biomolecules. For example, where an enzyme is the target biomolecule, target-specific compositions can be a small-molecule substrate that is subject to the enzymatic reaction catalyzed by that enzyme.

In one embodiment, target-specific compositions comprise one or more signal-generating moieties that generate detectable signals so that the target biomolecules can be detected and quantified in subsequent steps of detection and analysis.

In one embodiment, signal-generating moieties include but are not limited to chemiluminescent, fluorescent, and chromogenic substrates, as well as other substrates that are convertible to a product capable of being detected.

### Digital Detection and Quantification of Target Biomolecules

In one embodiment, the present invention comprises detection of target molecules using systems or devices that are capable of detecting signals indicative of the target molecules.

In one embodiment, the present method comprises a step of measuring the absolute count of signals indicating the presence of target biomolecules and thereby quantifying the target biomolecules in an absolute count. In one embodiment, the present method measures signals generated by the signal-generating moieties described herein.

In one embodiment, the present method comprises a step of quantitatively and independently measuring a specific signal from a plurality of droplets. Digital means the signal is either one or zero. For instance, the droplets with fluorescence are named as ‘positive’ (i.e., the droplets contain target molecule) and the droplets without fluorescence are ‘negative’ (i.e., no target molecule is present in the droplets).

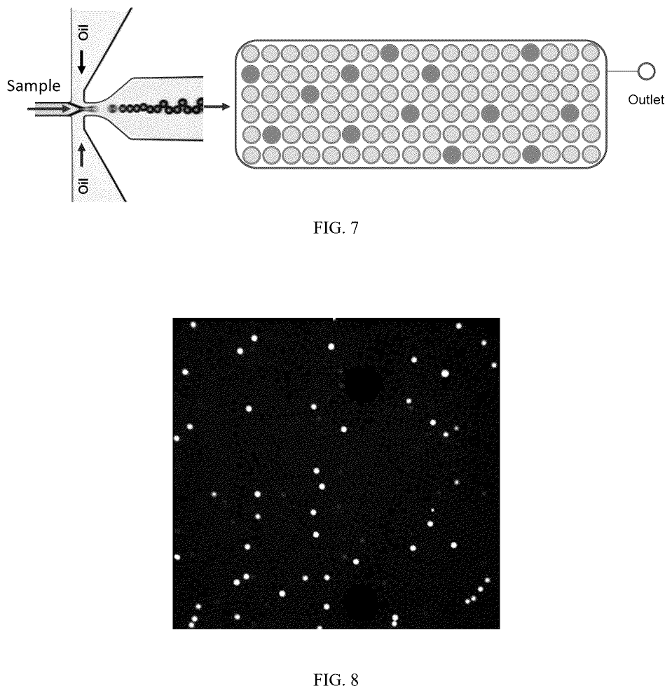

In one embodiment, signals to be detected are fluorescent signals, and systems or devices that are capable of capturing fluorescent signals and measuring the intensity of fluorescent signals are used. In one embodiment, a charge-couple device (CCD) is used to capture fluorescent signals and generates images of florescent droplets deposited in a chamber or on a chip. By counting the number of fluorescent droplets and intensity of fluorescent signals in each of the droplets, the florescent signals can be processed and analyzed. In one embodiment, florescent signals measured are processed and analyzed using a proprietary image processing code. FIG. 8 shows a florescence image of droplets obtained by a CCD camera.

In one embodiment, only one type of biomolecule is detected and quantified per single droplet.

In one embodiment, two or more types of biomolecules are detected and quantified per single droplet. For example, protein, nucleic acids, exosomes and/or other type of biomolecules are detected and quantified one after another in one single droplet.

In one embodiment, two or more species of biomolecules of the same type are detected and quantified per single droplet. For example, two or more species of nucleic acids (e.g. a DNA molecule and a RNA molecule) are detected and quantified per single droplet.

In one embodiment, when two or more types of biomolecules are to be detected and quantified per single droplet, one type of biomolecules is first detected and quantified per single droplet, then another type of biomolecules is detected and quantified per single droplet, and so forth. For example, one or more species of nucleic acids are first detected and quantified per single droplet, and then one or more species of peptides are detected and quantified per single droplet thereafter.

In one embodiment, the type of biomolecules detected and quantified in one droplet is different from the type of biomolecules detected and quantified in another droplet.

In one embodiment, the present invention detects 1-5 types of biomolecules per run. In another embodiment, the present invention detects 6-10 types of biomolecules per run. In yet another embodiment, the present invention detects 11-20 types of biomolecules per run.

In one embodiment, the present invention detects 1, 2, 3, 4, 5, 6, 7, 8, 9 or 10 types of biomolecules per run.

### Downstream Applications

In one embodiment, droplets produced are optionally collected for subsequent storage or downstream analysis. In one embodiment, droplets are collected from the outlet of the present integrated droplet microfluidic system. The collected droplets can be disrupted to extract and recover biological materials within the droplets. For instance, amplified DNA products in preceding reactions can be recovered from the droplets and subjected to further processing such as new-generation sequencing.

In one embodiment, all droplets generated are collected from the outlet, disrupted to obtain a suspension of their content. The suspension is then partitioned into droplets and analyzed using the method or device described herein.

In one embodiment, all droplets generated are collected from the outlet and then sorted for containing a target molecule. For example, the collected droplets can be loaded into a microfluidic sorting device for screening. In brief, droplets collected are injected into the sorting device as a monodisperse emulsion, and the emulsion droplets are kept apart with surfactant-free fluorinated oil. The droplets are deflected as they pass through a sorting junction having an alternating current (AC) electric field (Baret, Jean-Christophe, 2009).

In one embodiment, droplets collected from the outlet or sorted are subject to further manipulation such as treatment with addition of reagents and incubation under appropriate conditions.

Examples 2-5 describe detection of different types of biomolecules using the present invention. The following are explementary descriptions illustrating how the present invention can be used to detect or quantify a wide range of bio molecules that are indicative of a disease state. However, one skilled in the art will readily appreciate that the examples and descriptions provided are merely for illustrative purposes and are not meant to limit the scope of the invention which is defined by the claims following thereafter.

### Detection of Microorganism by Co-Detection and Quantitation of DNA and RNA

In one embodiment, the present invention provides a method for detecting a pathogenic microorganism present in a sample such as food, feed and plant, or any solution or suspension derived therefrom. The present method is important in ensuring the safety of food as well as preventing the spread of microbes.

In one embodiment, the method for detecting apathogenic microorganism comprises a step of detecting and quantifying biomolecules that are indicative of the presence of the pathogenic microorganism in question, wherein the method partitions the sample into droplets and performs digital detection and analysis against the target pathogenic microorganism using methods and devices described herein. In one embodiment, biomolecules to be detected are nucleic acids and/or proteins possessed by the target pathogenic microorganism.

In one embodiment, multiple species of nucleic acids of the target pathogenic microorganism are detected and quantified by the present invention. Since the genome of a pathogen can be made of DNA, RNA or both, a multi-functional detection or diagnostic tool that is able to amplify and detect both RNA and DNA targets in an efficient and sensitive manner would be particularly useful in clinical practices. Example 2 provides one example of co-detecting DNA and RNA down to the single molecular level. By detecting or quantifying related DNA or RNA biomarkers, the present invention can be used for detecting any organisms, tissues, cells and moieties, alive or dead, comprising these DNA or RNA biomarkers.

In one embodiment, nucleic acids and protein of the pathogenic microorganism are detected and quantified concurrently by the present invention.

### Droplet Dispersion and Formation of One-Laver Configuration

The present invention primarily focuses on microdroplet preparation to enable droplets to form a planar, one-layer arrangement, reducing droplet breakage compared with traditional droplet methods. Additionally, when these droplets are used for testing or subsequent screening, they can sequentially enter the screening channel as single droplets. This has a significant improvement over traditional droplet distribution method.

In traditional droplet generation, although one-layer configuration methods are also employed, the micropillars are uniformly distributed, and a plurality of micropillars are uniformly distributed throughout the storage space. When droplets are forced by inlet pressure to pass through these micropillars and flow out from the outlet, the pressure combined with the effective space between the micropillars causes many droplets to break or rupture during movement, resulting in a low preservation rate of intact effective droplets. This leads to significant losses in both subsequent droplet testing and droplet sorting. After all, only when microdroplets remain intact can any subsequent actions be effectively performed on them, such as detecting analytes within the droplets or separating them into negative or positive groups. Additionally, when droplets break, they inevitably release numerous substances, which become impurity components. These impurity components mix with the oil phase between droplets, further affecting droplet flow, particularly hindering droplet flow. This requires applying greater pressure at the inlet. Moreover, the presence of impurity components complicates subsequent droplet processing, such as screening. For example, if impurities contain target substances or labeled substances, during detection, it becomes impossible to distinguish whether these marker substances come from independent droplets or are released into the oil phase by ruptured droplets, causing difficulties in subsequent detection or sorting. It can be understood that generally, droplets are in the form of water-in-oil, where the water contains liquid samples or components such as cells within the liquid samples. The prepared droplets enter the storage space with the oil phase from the inlet.

The present invention precisely overcomes certain defects of traditional technologies by providing a stepped distribution mode, enabling droplets to gradually or stepwise enter a small and narrow space from a relatively large space. This allows the resistance encountered by droplets during movement to gradually increase, so that the resistance is relatively small in the early stage of movement and gradually increases in the later stage. In this way, the chance and force of mutual squeezing between droplets are reduced, which can effectively reduce droplet breakage.

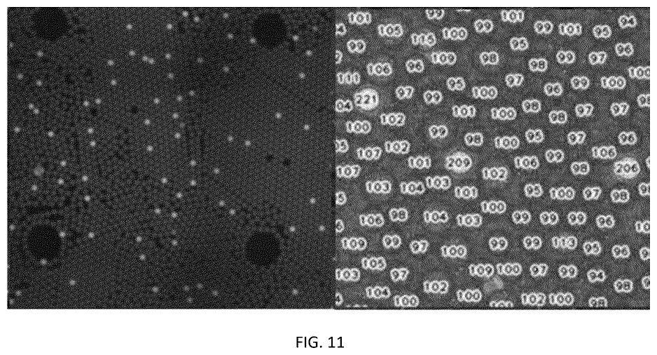

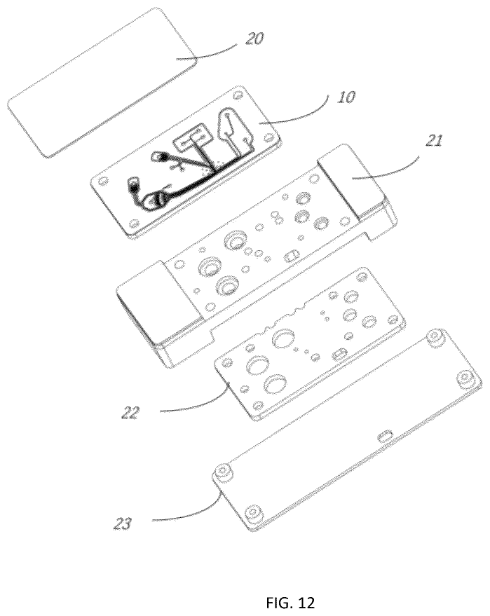

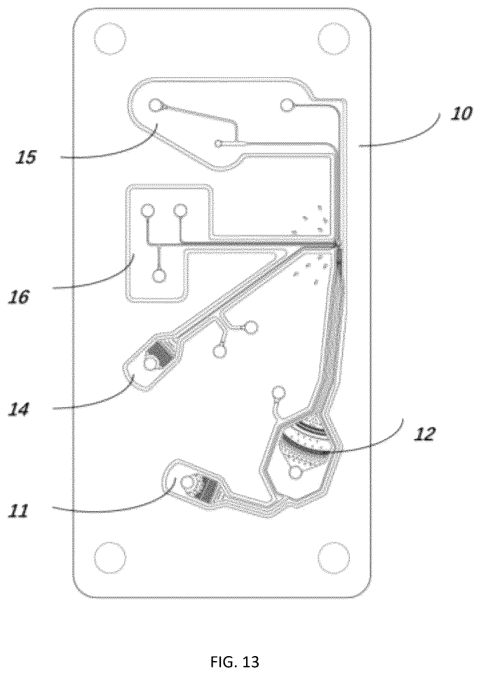

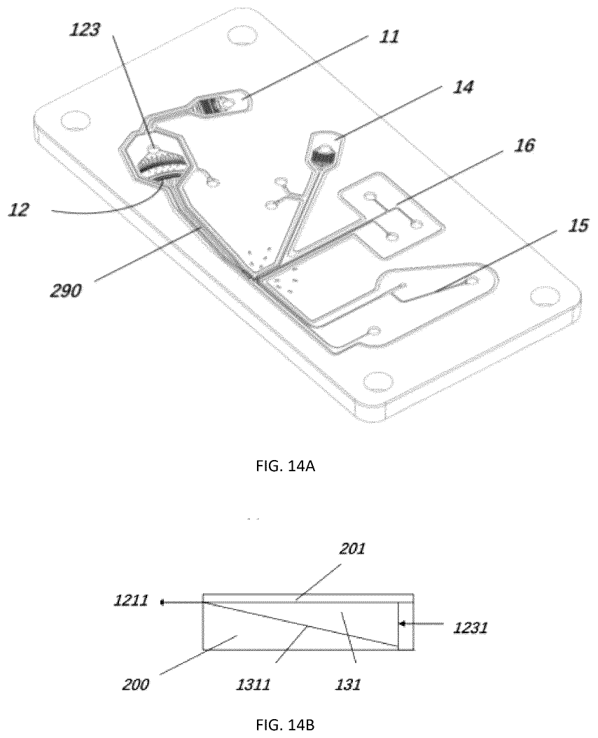

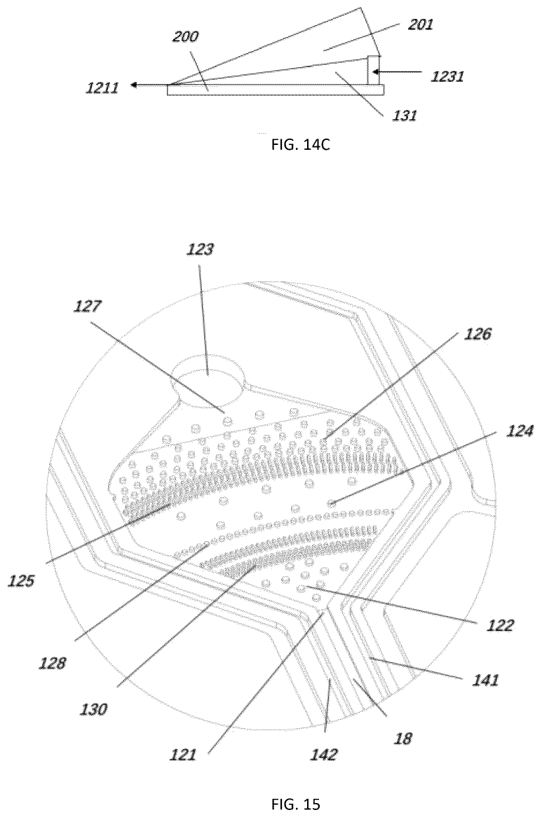

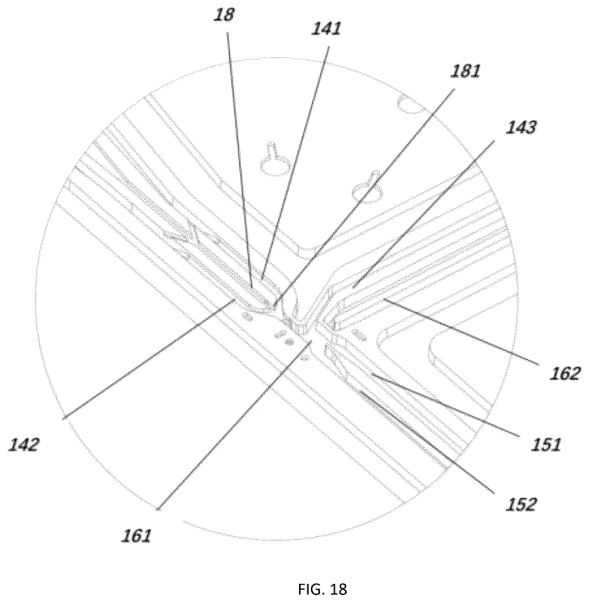

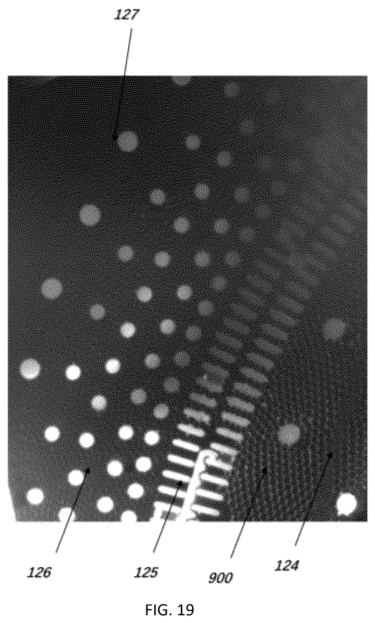

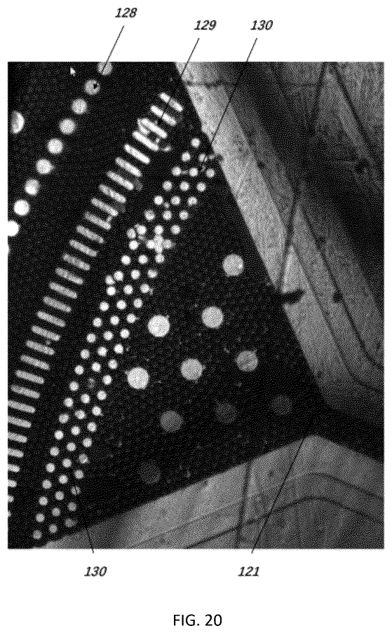

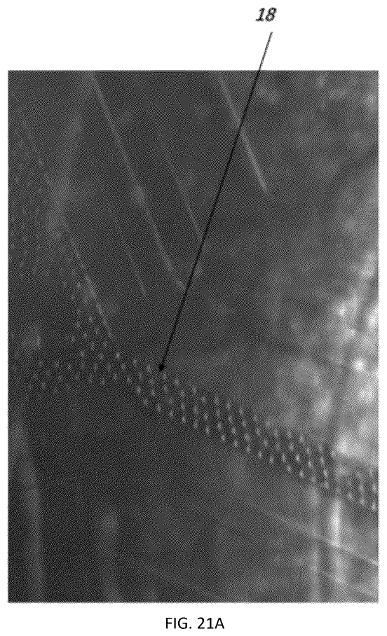

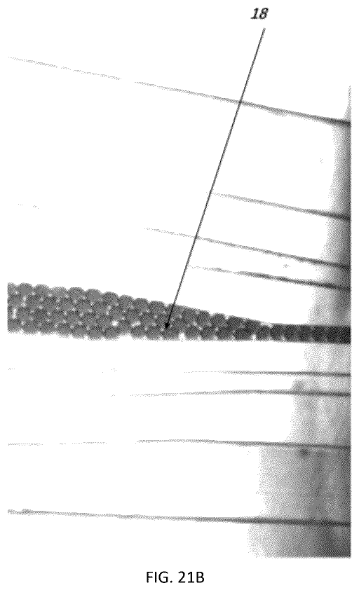

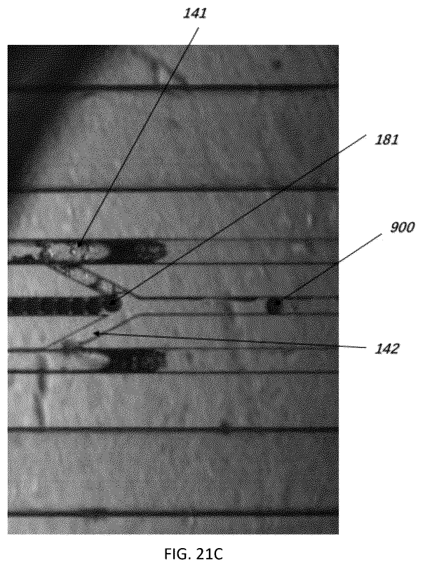

As shown in FIGS. 12 to 21C, in some embodiments, the droplet arrangement device of the present invention includes a droplet inlet 123, a droplet outlet 121, and a droplet storage space 12 between therebetween. Within this space 12, the resistance encountered by droplets at the inlet 123 is less than or far less than that at the outlet 121. This creates a gradual increase in resistance from the inlet 123 to the outlet 122, thereby reducing droplet breakage rates. This improves upon traditional methods where droplets experienced uniform resistance throughout the storage space from inlet to outlet. In some embodiments, to achieve a gradual increase in resistance within the storage space (from the droplet inlet 123 to the droplet outlet 121), one approach is to dispose a bottom face 200 of a storage space 131 in an inclined manner (as shown in the schematic diagram of FIG. 14B). At a droplet inlet 1231, the height of the storage space is greater than or far greater than the diameter of a single droplet. For example, if the droplet diameter is 30 microns, the height is at least more than 30 microns, such as 35, 40, 60, 70, 80, 90, 100, 150, 200, 300, 400, or 500 microns. This allows droplets flowing out from the inlet to gather primarily at the inlet 123 with minimal resistance. Near an outlet 1221 where droplets flow out of the storage space, the height of the storage space is reduced to equal or less than the droplet diameter. When the bottom face is disposed in an inclined manner, the storage chamber is generally covered by an upper cover 201 to form the storage space 131, the droplet inlet 1231, the droplet outlet 1211, and is connected to the droplet generation apparatus (not shown) and the downstream droplet sorting apparatus through microfluidic channels. These storage spaces and microfluidic channels are generally fabricated on a substrate 10, and then the substrate 10 is covered by a cover plate 20 to form a sealed structure where each space is connected to the microfluidic channels 290. When the cover plate is planar, the inclined bottom face creates a high inlet and low outlet (FIG. 14B).

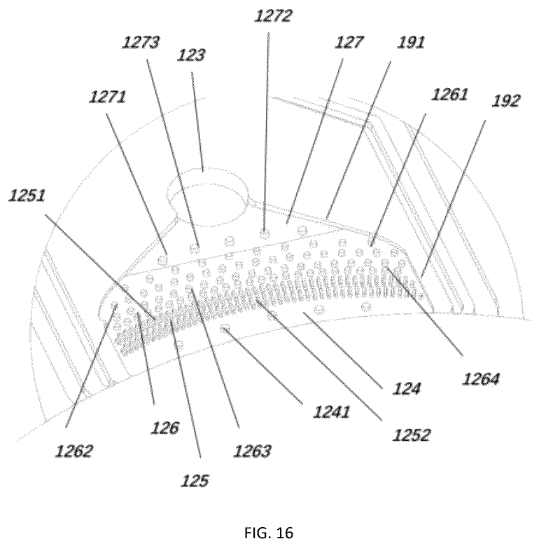

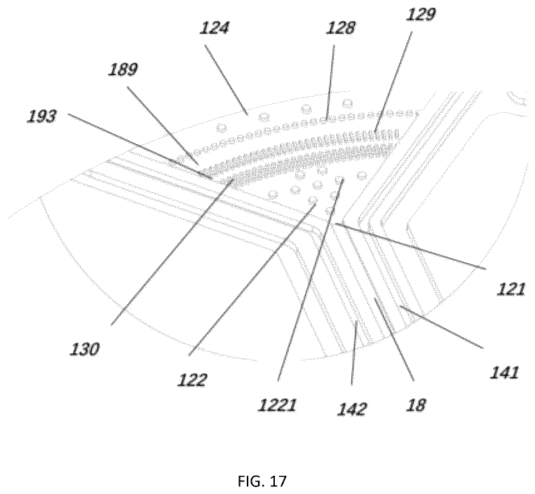

Another approach is to use a planar bottom face rather than an inclined bottom face (as shown in the schematic principle diagram of FIG. 14C and the schematic diagrams of FIG. 16-17), but the height of the storage space 131 is varied from high to low by adjusting the heights of surrounding walls 191, 192, and 193. At the droplet inlet 1231 where droplets flow into the storage space, the wall height of the storage space is greater than or far greater than the droplet diameter, while at the droplet outlet 1211, the wall thickness or height is essentially equal to or less than the droplet diameter. Since the height of the space 131 is determined by the heights of the surrounding walls of the storage chamber 131, the overall height of the storage chamber gradually decreases as the wall heights or thicknesses change. Thus, the entire storage space appears to be disposed in an inclined manner. In this case, the thickness of the cover plate varies across the storage space: it is thinner at the inlet 1231 and thicker at the outlet 1211. This causes the height of the entire storage space 12, 131 to increase at the inlet 1231 and gradually decrease toward the outlet 1221.

In some embodiments, the height of the storage space 12 can decrease gradually or in stages. For example, the height transitions from 200 microns at the droplet inlet 123 to 80 microns in the middle section, and then from 80 microns in the middle to 20-30 microns at the outlet (when the droplet diameter is 30 microns). In some embodiments, the height in the region upstream of the outlet 121 is less than or equal to the droplet diameter, causing droplets to be squeezed into a flattened state within this region. When the droplets are squeezed into a flattened state, it is more conducive to enabling the droplets to have a one-layer configuration. The degree of flattening should be maximized without causing droplet breakage. For example, if the droplet diameter is 30 microns, the height upstream of the outlet can be set to 20 microns; if the droplet diameter is 50 microns, the height can be set to 30 microns. This variation in height can be a gradual decrease from upstream to downstream. For example, it may gradually decrease from 80 microns (greater than the droplet diameter) upstream to 50 microns, and then further decrease to 30 microns. This decrease can be uniform and gradual, with the bottom face of the storage chamber forming a smooth curved inclined plane (without considering micropillars or other filtration mechanisms). The height can also decrease in stages. For example, it extends a certain distance at a height of 80 microns, then decreases to 70 microns and extends for a distance at the height of 70 microns. After that, it decreases from 70 microns to 50 microns, and then from 50 microns to 30 microns, similar to a stepped reduction.

In some embodiments, to reduce the resistance on droplets at the inlet 123, a first blank region 127 can be disposed in the downstream region of the inlet 121 without clusters of droplet-dispersing micropillar, forming an empty space that hardly imposes substantial resistance on droplets. In this way, droplets can continue to flow downstream in the resistance-free region without substantially coming into contact with the dispersing micropillars. Generally, droplets emerging from the droplet inlet 123 are contained in an oil phase. To enable the droplets to flow forward, pressure needs to be applied by the droplet generation apparatus, causing the oil phase containing droplets to flow through the microchannels and reach the droplet outlet 121.

In some embodiments, a region 122 with almost no substantial resistance to droplets can be disposed in the immediate upstream region of the droplet outlet 121. This region is free of droplet-dispersing micropillars and remains a planar, blank region (it can also be a gently inclined region). This region relies on the height of the storage space to restrict the entry of droplets into the planar region, thereby facilitating the formation of a one-layer droplet distribution. However, no droplet-dispersing micropillars are disposed in this region, reducing the risk of droplets being squeezed and ruptured due to contact with the dispersing micropillars.

In some embodiments, a plurality of clusters of droplet-dispersing micropillars are disposed within the storage space 12. These clusters of micropillars serve to gradually disperse the droplets. Throughout the storage space, the micropillars do not substantially occupy the entire region but are instead partitioned and disposed in partial regions. A portion of the space is left without dispersing micropillars, allowing droplets to enter regions free of substantial dispersing micropillars after passing through the dispersing micropillars, and then re-enter regions with dispersing micropillars. This approach reduces the chance for droplets to frequently come into contact with the dispersing micropillars, thereby reducing the chance of droplets being squeezed and broken by the micropillars. Meanwhile, it does not affect the flow velocity of droplets and even accelerates their flow velocity. In some embodiments, instead of placing micropillars that do not substantially disperse droplets downstream of the droplet inlet 123, a first blank region 127 (or 121 as previously mentioned) is reserved to allow droplets to accumulate more densely near the inlet. In some embodiments, from the blank region downstream, a cluster of first droplet-dispersing micropillars 126 is disposed. Along the droplet flow direction (from upstream droplet inlet to downstream droplet outlet), the distance between micropillars in the cluster of first droplet-dispersing micropillars gradually decreases. For example, the distance between droplet-dispersing micropillars in a first row 1261 is 10-15 droplet diameters, the distance between micropillars in a second row 1262 is 8-10 droplet diameters, the distance between micropillars in a third row 1263 is 5-8 droplet diameters, and the distance between micropillars in a fourth row can be 3-5 droplet diameters. This allows the droplets to be gradually dispersed through these dispersing micropillars with different distances. The dispersion here, on the one hand, gradually separates multi-layer droplets, and also spaces out the droplets through the dispersing micropillars, facilitating a planar one-layer arrangement downstream. Generally, dispersing micropillars are formed by etching onto the substrate 10, and their surfaces are not absolutely smooth. When droplets come into excessive contact with the dispersing micropillars under certain pressure, microstructures (rough) on the dispersing micropillars may puncture the droplets, leading to their rupture. In contrast, the present invention gradually increases the density of the droplet-dispersing micropillars and reduces the distance between the micropillars at the beginning. This reduces the chance of droplets coming into contact with the dispersing micropillars. Moreover, under the same pressure, the resistance naturally decreases, which not only facilitates the flow velocity of droplets at the inlet but also reduces the chance of droplet rupture.

In some embodiments, disposing the dispersing micropillars with a large distance allows the droplets to undergo initial separation. Unlike traditional approaches where dispersing micropillars are densely distributed with distances only wide enough for a single droplet to pass through, this increases the chance of droplets contacting the micropillars and naturally raises the breakage rate. In some embodiments, a second blank region 124 is disposed downstream of the cluster of first droplet-dispersing micropillars. This region contains almost no dispersing micropillars, allowing the initially dispersed droplets upstream to converge within the blank region. At this time, the height of the storage chamber may be 80-100 microns. Although this height still exceeds the droplet diameter, the gradual and smooth reduction in height reduces the number of droplets entering the downstream region, facilitating the subsequent formation of a one-layer configuration. Additionally, the blank region 124 is free from the resistance of dispersing micropillars, making it a region with no resistance or obviously lower resistance than that in the first dispersing micropillar region. In some embodiments, a cluster of second droplet-dispersing micropillars 128 is disposed downstream of the second blank region 124. The distance between the cluster of micropillars gradually decreases, allowing only single, 2, 3, or fewer droplets to pass through. The cluster of micropillars can be disposed as a single row or multiple rows. In some embodiments, a cluster of third dispersing micropillars 130 is disposed downstream of the second dispersing micropillars. These dispersing micropillars can be disposed in multiple rows to allow only a single droplet to pass through, thereby enabling uniform separation of droplets here, causing them to flow into the third blank region 122 almost in a single layer and converge. In some embodiments, the distance disposed between the cluster of second dispersing micropillars 128 and the cluster of third dispersing micropillars 120 is relatively large, and a blank region 189 without any clusters of micropillars is disposed therebetween, which can be regarded as a fourth blank region.

The last rows 1301, 1302 of droplet-dispersing micropillars allow only single droplets to pass through. After passing through, the droplets enter the third blank region 122, which is adjacent to the outlet 121. Here, a one-layer droplet distribution is formed, and then the droplets flow into a downstream droplet channel 18 and exit through a channel outlet 181 for detection. The detection determines whether the droplets are positive or negative, enabling screening for different purposes, for example, collecting positive droplets while discarding negative ones.

In summary, adoption of multi-layer clusters of droplet-dispersing micropillars disposed at intervals with blank regions reducing resistance disposed between each cluster of micropillars facilitates the flow velocity of droplets through this configuration. Additionally, it facilitates the formation of a one-layer droplet arrangement at the final inlet. In traditional approaches, the storage space between the inlet and the outlet is designed to achieve a one-layer distribution from the start, utilizing densely packed dispersing micropillars, with the distance between the dispersing micropillars allowing only 1-2 droplets to pass through. This attempt to achieve a one-layer distribution throughout the space not only impedes the flow of droplets but also leads to high-frequency droplet rupture. This can also be understood as follows: the plurality of clusters of dispersing micropillars are disposed at intervals, with spacing regions or blank regions between the clusters of micropillars that offer almost no resistance. In this way, after droplets are separated by the previous clusters of dispersing micropillars, they enter a low-resistance region to converge, then enter the next clusters of dispersing micropillars for separation, and then enter another blank region with even smaller resistance. Through this approach, the flow velocity of droplets is facilitated, and rupture is reduced. For example, the resistance encountered by droplets in the cluster of first dispersing micropillars 126 is greater than that in the blank region 124. The droplets then enter the second dispersing micropillars 128 for re-separation, followed by the fourth blank region 189 with relatively lower resistance. They subsequently enter the cluster of dispersing micropillars 130 with greater resistance, and then flow into the third blank region 122 with lower resistance. In fact, the resistance exerted by different clusters of dispersing micropillars on droplets gradually increases, while the blank regions hardly impose any resistance on the droplets.

Our experiments show that in the same storage space with uniform height (without any slopes) and fully packed with dispersing micropillars of identical density, where only 1-2 droplets can pass through, the breakage rate of liquid from inlet to outlet reaches over 50-60%. Additionally, the flow velocity is relatively slow, requiring greater pressure at inlet 123 to push droplets through the traditional storage chamber. In contrast, with the configuration of the present invention, when the dispersing micropillars are disposed at intervals (with blank regions without dispersing micropillars), the breakage rate of the droplets is only 30-40%. Although a single layer is formed at the outlet, the area of the single layer is very small. If the spaced dispersing micropillars are disposed in combination with a storage space decreasing from high to low in height, the droplet breakage rate is only 5-10%, and a large-area one-layer droplet arrangement is formed at the outlet.

In some embodiments, impurity filtration regions 125, 129 are further disposed within the storage space. These impurity filtration regions function to filter out impurities such as fibers from the droplet solution, preventing them from entering downstream regions. In some embodiments, the impurity filtration region may be provided with two rows 1251, 1252, each row having filter ribs disposed at intervals. Passages are disposed between ribs, allowing droplets to freely pass through the passages, while transverse fibers in the oil phase cannot pass through and are blocked in the upstream region. In some embodiments, the first impurity filtration region 125 is disposed downstream of the first dispersing micropillars 126 for preliminary filtration of large impurities. At this time, the distance between the pillars of the first dispersing micropillars is large, and the first impurity filtration region 125 can filter large impurities such as long fibers.

The second impurity filtration region 129 is disposed downstream of the fourth blank region 189 to filter out smaller impurities. Each row has filter ribs disposed at intervals with passages therebetween, allowing droplets to freely pass through. The distance of the passages here is shorter than that in the first impurity filtration region, preventing smaller impurities from entering the downstream the cluster of third dispersing micropillars 130. This reduces the impurity content in the droplets forming a one-layer configuration, thereby facilitating downstream droplet screening. Downstream of the filtration region 129, droplets are nearly squeezed, and impurities may also damage or rupture them. Therefore, a second filter is disposed upstream of the cluster of third droplet dispersing micropillars to block smaller impurities from entering the droplets with a one-layer configuration and causing damage. In some embodiments, droplets are already pressurized and flattened within the third blank region 122. While a one-layer distribution forms in the third blank region 122, the droplets may not be squeezed. For example, the height here is set to the droplet diameter. When droplets enter the channel 18, whose depth may be smaller than the droplet diameter, they are squeezed into an elliptical or flattened shape and flow sequentially to the channel outlet 181 for testing. The spacer oil collected at the channel outlet 181 spaces out the droplets, facilitating subsequent screening by an electric field.

The “storage layer,” “storage chamber,” “storage space,” and “droplet storage chamber” here can be used interchangeably and understood to have the same meaning. In fact, it provides a space for droplet storage. This storage space can be used for droplet testing, such as detecting various reactions on droplets to test cells or nucleic acid amplification, etc., and can also serve as a space for droplet arrangement before subsequent droplet screening. The storage here does not refer to maintaining droplets for a long time, but serves as a transitional space. For example, it acts as a space for the process of transforming liquid from a multi-layer to a one-layer arrangement, where the final one-layer arrangement is achieved within this space. Since there is storage, there is a droplet inlet. The inlet is where droplets are generated by a droplet generation device and then flow into the storage space through the inlet. In this space, droplets can be distributed into a single layer.

In some embodiments, a channel 18 is disposed downstream of the droplet outlet 121. This microchannel is connected to the droplet storage space 12, allowing the droplets of a one-layer arrangement formed in the storage space to enter the microchannel 18. In some embodiments, the depth of the channel is smaller than the droplet diameter, so that droplets can only enter the channel 18 sequentially as single units and then flow to the channel outlet 181. At the outlet 181, the droplets are flattened within the channel, and at the channel outlet 181, the droplets undergo testing, for example, to identify those containing positive substances (target droplets desired) and those with negative substances (non-target droplets undesired).

In some embodiments, one or more support pillars (1271, 1273, 1272, 1241, 1242, 1221) are disposed in the first blank region 127, the second blank region 124, and the third blank region 122. The purpose of the support pillars is to support the cover 20, preventing the cover from coming into contact with the bottom of the storage chamber. These support pillars are widely spaced, causing almost no substantial resistance to the droplets and not separating them either. Especially when the support pillars are disposed in the third blank region, since the cover plate is extremely close to the bottom of the storage chamber in this region (approximately the diameter of a droplet or smaller), if the support pillars are disposed, the cover plate may come into contact with the bottom of the storage chamber, which is not conducive to the one-layer arrangement of droplets. In some embodiments, the height of the support pillars at the inlet is significantly greater than that at the outlet.

### Droplet Screening

In one embodiment, the generated droplets can be arbitrarily collected for subsequent storage or downstream analysis. In one embodiment, droplets are collected from the channel outlet 181 of the present invention. The collected droplets can be lysed to extract and recover biological materials within the droplets. For example, DNA products amplified in previous reactions can be recovered from the droplets and used for further processing such as next-generation sequencing.

In one embodiment, all generated droplets are collected from the channel outlet 181 and lysed to obtain a suspension of their contents. The suspension is then partitioned into droplets and analyzed using the methods and devices described herein.

In one embodiment, all generated droplets are collected from the channel outlet 181, and then droplets containing target molecules are sorted. For example, droplets exiting from the outlet 181 can be loaded into a downstream microfluidic sorting device 16 for screening. Specifically, droplets exiting from the channel outlet 181 are first tested to determine whether they are positive target droplets or negative non-target droplets. The droplets are then spaced apart by injecting spacer oil 11 and introducing into microchannels 141, 142, ensuring that each droplet is separated downstream of the channel outlet 181. The droplets then flow into a sorting channel 161, where carrier oil is injected via an oil-phase microchannel 143 of the carrier oil flow 14. A voltage is then applied through an electrode group 16 for an electric field, specifically through electrodes 162 for an alternating electric field, causing positive droplets to enter a positive channel 151 and negative droplets to enter a negative channel 152. Positive droplets are collected at an outlet 1511 of the positive channel, while negative droplets are collected at an outlet 1521 of the negative channel, thereby achieving droplet sorting. Certainly, an exhaust channel 171 is also disposed to facilitate the discharge of gas from the channel, ensuring smooth outflow of droplets from the channel. In some implementations, a sorting device is disposed below the droplet arrangement device. The sorting device includes a sorting electric field and a sorting channel to achieve sorting of positive and negative droplets. The droplet arrangement device is in communication with the sorting device via a microchannel. When droplets pass through a sorting junction with an alternating current (AC) electric field, they are deflected (Baret, Jean-Christophe, 2009). This enables the separation of droplets, and these droplet sorting technologies are conventional methods. For specific sorting details, reference may be made to the applicant's U.S. Patent Application No. US20230285971A1 or existing disclosed technologies.

In some implementations, such as shown in FIG. 1, a system is provided, including a droplet arrangement device, an electrode separation device 16, a droplet collection and separation device 15, and optionally a droplet generation device. These devices are integrated on a substrate 10 with microchannels and various chambers disposed thereon. The microchannels and chambers on the substrate are sealed by a cover plate 20 to form closed channels and chambers. The devices are in fluid communication through the microchannels. In some implementations, the substrate is disposed on a base 21, and the base is provided with openings for external connections to the substrate 10. For example, when the droplet generation device is externally installed, droplets generated by the droplet generation device enter an arrangement chamber 12 through a microchannel connected to the droplet inlet 123 of the arrangement chamber. Negative or positive droplets flowing from the screening channel then enter containers for droplet collection through the respective channel outlets 1521, 1511. A bottom plate 23 is disposed in the system. The base is disposed on the bottom plate via a spacer plate 22, a microchannel system is disposed on the base, and the cover plate 20 covers the substrate 10.

### Co-Detection and Quantitation of Nucleic Acids and Proteins

In one embodiment, the present invention provides a method for co-detecting nucleic acids and proteins in a sample.

In one embodiment, the present invention provides a method for co-detecting and/or quantifying one or more protein markers and one or more nucleic acid markers indicative of a certain disease or health condition, thereby determining the existence or extent of such disease or health condition in a subject.

Example 3 provides one example of co-detecting and quantifying multiple protein markers and nucleic acid markers for detecting solid tumors prior to metastases.

For example, it was reported that a combination of four protein biomarkers with one genetic marker (KRASmutation) could enhance the sensitivity for the detection of pancreatic cancers (Cohen, 2017), and a blood test can detect eight common cancer types (ovary, liver, stomach, pancreas, esophagus, colorectum, lung, and breast) through assessment of the levels of circulating proteins (8 proteins) and mutations in cell-free DNA (16 genes) (Cohen, 2018).

Co-Detection and Quantitation of Proteins and Messenger RNA (mRNA)

In one embodiment, the present invention provides a method for co-detecting proteins and mRNA in a sample. Example 4 provides one example of co-detecting and quantifying proteins and messenger RNA in a sample.

Integrated co-detection of proteins and mRNAs from the same cell has the potential to not only reveal the correlation between these two classes of biologically important molecules, but also help understand the mechanisms of gene regulation, at both the transcriptional and translational levels.

### Co-Detection and Quantitation of DNA, RNA and Protein in an Exosome

In one embodiment, the present invention provides a method for co-detecting and quantifying DNA, RNA and protein in an exosome. In another embodiment, the present invention provides a method for quantifying the number of exosomes in a sample in an absolute manner.

Example 5 provides one example of co-detecting and quantifying DNA, RNA and proteins in a single exosome, and absolute quantification of exosomes in a sample.

Exosome contains biomolecules including DNA, RNA and protein within its lumen or on its lipid membrane. These molecules can be extracted from an exosome isolated from a sample such as serum. With the present invention, absolute count of exosome scan be achieved digitally using ExoELISA method, or absolute count of individual biomolecules such as DNA, RNA or protein can be achieved digitally using digital PCR or digital ELISA. Information about the count of these biomolecules can be coupled or pooled for analysis for diagnostic purpose or otherwise.

### Evaluation of the Validity of Results of a Bioassay

In one embodiment, the present invention provides a method for evaluating the validity of results of a bioassay based on the quantity of target biomolecules determined by the steps described above. For example, where the quantity of a target biomolecule in a sample is found to fall below the detection limit of a bioassay, or the relative amount of DNA and RNA molecules in a sample is found to fall outside the normal ranges, the results obtained by the bioassay may not be accurate. A newly collected sample or concentration of the original sample may be needed to validate the results.

### Determination or Evaluation of the Health Status of a Subject

In one embodiment, the present invention provides a method for determining or evaluating the health status of a subject based on the quantity of target biomolecules determined by the methods or devices described herein.

Since the present invention provides an accurate quantification of target molecules in a highly specific and sensitive manner, the present invention can significantly improve the sensitivity, specificity and accuracy of biomarker-based diagnostic tests, in particular those which rely on the absolute quantity of the biomarkers. For example, by providing an accurate absolute count of a pathogen or a type of cancer cell in a subject, the present invention can differentiate patients of various risk levels, infectious levels, or having different stages of cancer.

In one embodiment, the present method comprises a step of determining the presence or absence of a condition that is indicative of a disease or health condition of a subject based on the quantity of target biomolecules determined by the methods or devices described herein.

In one embodiment, the present method comprises a step of determining the stage of progression of a disease based on the quantity of target biomolecules determined by the methods or devices described herein.

In one embodiment, the present method comprises a step of evaluating a drug response of a subject based on the quantity of target biomolecules determined by the methods or devices described herein.

In one embodiment, diseases to be detected or diagnosed using the present methods or devices include, without limitation, cancers, infectious diseases, endocrine diseases, metabolic diseases, genetic diseases, diseases of the nervous system and sense organs, diseases of the circulatory system, diseases of the respiratory system, diseases of the digestive system, diseases of the genitourinary system, diseases of the skin and subcutaneous tissue, diseases of the musculoskeletal system and connective tissue, and congenital anomalies.

In one embodiment, the present invention provides a method for real-time and digital count of target biomolecules in a sample containing said target biomolecules, the method comprises the steps of:
a) providing to a droplet generator said sample and reagents suitable for said method;
b) generating droplets with said droplet generator, wherein some droplets contain said reagents and said target biomolecules;
c) allowing said reagents to label said target biomolecules, producing fluorescent signals;
d) detecting fluorescent signals from all droplets; and
e) converting said signals into digital values to obtain the total number of said target biomolecules in said sample.

In one embodiment, the present invention provides a method for real-time and digital count of cells or exosomes containing target biomolecules in a sample containing said cells or exosomes, the method comprises the steps of:
a) providing to a droplet generator said sample and reagents suitable for said method;
b) generating droplets with said droplet generator, wherein some droplets contain said reagents and said cells or exosomes;
c) allowing some of said reagents to lyse said cells or exosomes to release said target biomolecules, and then some of said reagents to label said target biomolecules, producing fluorescent signals;
d) detecting fluorescent signals from all droplets; and
e) converting said signals into digital values to obtain the total number of said cells or exosomes in said sample.

In one embodiment of the present method, wherein in step b) each of said some droplets contains no more than one copy of the target biomolecules of the same type. In one embodiment, wherein in step b) each of said some droplets contains no more than one copy of the cells or exosomes.

In one embodiment of the present method, wherein the target biomolecules to be labelled in step c) are of the same type or different types.

In one embodiment of the present method, wherein the method detects 1-10 types of target biomolecules.

In one embodiment of the present method, wherein the target biomolecules are selected from the group consisting of nucleic acids, peptides, proteins, enzymes, viruses and microorganisms.

In one embodiment of the present method, wherein the nucleic acids are selected from the group consisting of coding DNA, non-coding DNA, messenger RNA, ribosomal RNA, micro-RNA and transfer RNA.

In one embodiment of the present method, wherein steps (c) and (d) are performed concurrently to detect fluorescent signals in real time.

In one embodiment of the present method, wherein step (d) is performed continuously or intermittently when the target biomolecules are being labelled in step (c).

In one embodiment of the present method, wherein the method further comprises a step of collecting the droplets after any one of steps (c)-(e).

In one embodiment of the present method, wherein the droplets collected are disrupted to obtain a suspension comprising labelled target biomolecules.

In one embodiment of the present method, wherein the droplets collected are introduced to a droplet sorting unit to select droplets containing a particular type of target biomolecules or having particular properties.

In one embodiment of the present method, wherein the droplet generator comprises a structure selected from the group consisting of a flow focusing structure, a crossflowing structure, a co-flowing structure, a step emulsion structure and a microchannel emulsification structure.

In one embodiment of the present method, wherein the sample and reagents are introduced to the droplet generator through the same inlet or different inlets.

In one embodiment of the present method, wherein fluorescent signals are detected by a charge-couple device.

In one embodiment of the present method, wherein the droplets have a diameter in the range of 5 μm to 200 μm.

In one embodiment of the present method, wherein the quantity of droplets generated ranges from several hundreds to several millions.

In one embodiment of the present method, wherein the method is carried out on an integrated droplet microfluidic system comprising said droplet generator, a droplet storage chamber, a detection unit and a plurality of microfluidic channels.

In one embodiment of the present method, wherein the total number of said target biomolecules is indicative of the severity or lack of a disease.

In one embodiment, the present invention provides a method for diagnosing a disease in a subject, the method comprises the step of determining the absolute quantity of a biomarker of said disease in a sample of the subject, wherein said absolute quantity is determined by using any one of the methods described above, wherein said biomarker is the target biomolecule present in said sample or present in the cells or exosomes in said sample, wherein the absolute quantity of said marker as compared to a control indicates the presence, severity or absence of said disease in said subject.

Throughout this application, various publications are cited. The disclosures of these publications in their entireties are hereby incorporated by reference into this application to more fully describe the state of the art to which this invention pertains.

Throughout this application, it is to be noted that the transitional term “comprising”, which is synonymous with “including”, “containing” or “characterized by”, is inclusive or open-ended, and does not exclude additional, un-recited elements or method steps.

This invention will be better understood by reference to the examples which follow. However, one skilled in the art will readily appreciate that the examples provided are merely for illustrative purposes and are not meant to limit the scope of the invention which is defined by the claims following thereafter.

### EXAMPLES

### Example 1—Integrated Droplet Microfluidic System

This example illustrates one embodiment of the present digital quantification system which is integrated in one microfluidic chip. The microfluidic chip is formed by a droplet generator and a droplet storage chamber. The droplet generator can be the structures of flow focusing, T-junction or step emulsion. The droplet storage chamber design depends on the total number and volume of droplets desired for a specific assay. The height of the chamber is usually 1˜1.5 times the diameter of the droplets and the size of the chamber is larger than the total volume of the droplets. The resulting droplets are spread in a one-layer configuration on a microfluidic chip. After the sample compartmentalization is finished, reactions happen in situ in parallel in all droplets. Once the reactions are completed, a microscopic camera and a X-Y motion stage are coupled together to take the image of the droplets on the whole microfluidic chip. The images are processed by a computer for digital counting and data analysis.

FIG. 1 shows one embodiment of the present integrated droplet microfluidic system.

FIG. 2 shows one embodiment of the present invention comprising an integrated droplet microfluidic system for digital quantification of biomolecules inside each of the droplets. The present micro fluidic system includes four parts (from left to right): inlets, a droplet generator, a droplet storage chamber and an outlet. Inlets are used to introduce various liquids (e.g. oil, samples and reagents for carrying out reactions) to the droplet generator, where these liquids can be loaded separately through different inlets (as shown in FIG. 2), or premixed and loaded as a mixture through the same inlet. Sample containing biomolecules is prepared and compartmentalized into isolated droplets through the droplet generator; the droplets generated are then spread in a one-layer configuration in a droplet storage chamber. After sample compartmentalization, parallel in situ reactions happen in the individual droplets, wherein the reactions are part of a reaction assay for analysing the target biomolecules, and the reactions in different droplets can be the same or different. Once the reactions are completed, signals that indicate the presence of target biomolecules are detected by, for example, capturing the image of the droplets in the droplet storage chamber using a microscopic camera. The images are then processed by computer for digital counting and data analysis. Outlet is for removal of liquid or gas from the system. In one embodiment, outlet is for air or oil draining. In another embodiment when droplets need to be collected after reactions, they can be collected from the droplet storage chamber through the outlet.

### Example 2—Co-Detection and Quantitation of DNA and RNA from a Single Cell/Exosome at the Molecular Level

This example illustrates one example of using the present invention for the detection of pathogenic microorganisms present in food, feed, plant, or other samples. This is important for providing safe food as well as for preventing the spread of microbes. Since the genome of pathogens is made of DNA and/or RNA, a multi-functional diagnostic tool that is able to amplify and detect both RNA and DNA targets in an efficient and sensitive manner would be particularly useful in clinical practices.

For DNA targets, digital PCR can be used for absolute counting of DNA molecule using specific primers and reagents co-encapsulated in the droplets.

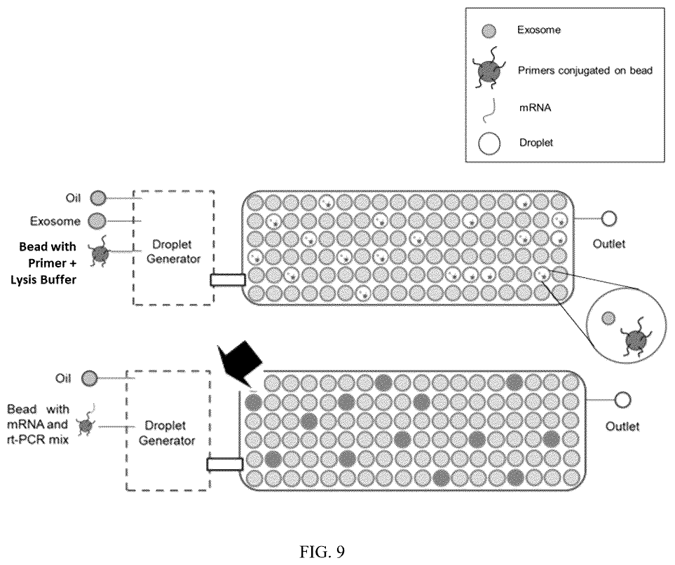

For RNA targets, digital RNA counting can be accomplished by digital PCR after the reverse transcription of the RNA extracted from cells. However, such method for absolute counting of RNA provides only the averages of cell ensembles and thereby unveils only the average genotypic/phenotypic traits of the cell population. For absolute counting of the RNA from a single cell or exosome, a system such as shown in FIG. 9 can be used, involving two rounds of encapsulation: one for single cell or exosome, and the other for single mRNA molecules.

As shown in the upper panel of FIG. 9, a single exosome (or single cell as the case may be), magnetic beads conjugated with primer specific to the target RNA and lysis buffer for lysing the exosome or cell are encapsulated into one droplet by the droplet generator. Droplet generation may take the form shown in FIG. 4. After droplets are generated, they are stored in the droplet storage chamber at the right. In each isolated droplet, the single exosome is lysed and the RNA contained therein is released and paired with the target-specific primer on the magnetic beads. Droplets are then collected from the outlet for subsequent analysis. All the collected droplets are then broken using a solvent (e.g. Perfluoro-1-octanol) to dissolve the oil phase and obtain an aqueous suspension of the magnetic beads with RNA from the single cell/exosome. A washing solution (e.g. PBS) is then added to the suspension followed by mixing with vortex. The mixture is then allowed to settle on a magnetic shelf. Components that are not necessary for subsequent rt-PCR reactions would be removed together with the washing solution by pipetting while the magnetic beads with primer conjugated with the target RNA are retained.

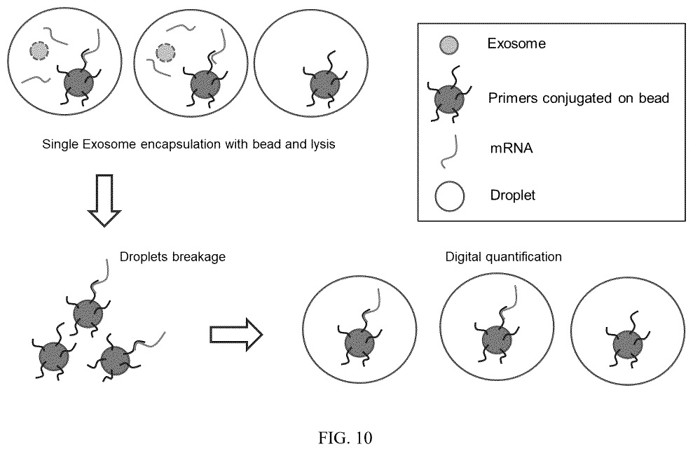

As shown in FIG. 10, mRNA molecules from one exosome are released after lysis of the exosome and will be conjugated with a target primer on the magnetic beads. Unnecessary components are washed away through washing steps. The resulting sample containing the beads with primer conjugated with mRNA will then be encapsulated into droplets for digital quantification of the mRNA.

As shown in the lower panel of FIG. 9, the magnetic beads with primer conjugated with mRNA are mixed with a reverse transcription mixture and PCR mixture (collectively rt-PCT mix) and then loaded into an integrated droplet microfluidic system for in situ reverse transcription and PCR thermal cycling. Droplet generation may take the form shown in FIG. 3 since reverse transcription and PCR are hot start reactions and therefore the mRNA sample and rt-PCT reaction mix can be pre-mixed before encapsulation. Fluorescent signals (as indicated by the darker dots in the droplet storage chamber in the lower penal of FIG. 9) are then detected digitally through a microscopic camera and absolute count of the RNA target from a single cell or exosome can be calculated.

FIG. 11 shows data of end-point digital detection of DNA using the present invention. PCR thermocycling was performed to amplify the target DNA in a sample. The resulting mixture was then partitioned into 100,000 droplets which were subsequently spread in the present droplet storage chamber in a one-layer configuration. Florescent signals that were indicative of the presence of target DNA were recorded using a camera and the intensity of fluorescent signals in each droplet was measured using an image processing program. The image on the left records fluorescent signals detected from droplets located in one region of the droplet storage chamber, while the image on the right shows the intensities of fluorescent signals of each of the droplets located in another region of the droplet storage chamber (each circle represents one droplet and a higher numerical value indicates a higher level of fluorescent signal). Absolute count of the target DNA was then calculated based on the signals detected.

In cases where multiple RNA molecules are to be detected from a population of cells or exosomes, it is possible that some cells or exosomes may not contain every species of the target RNA molecules, or some cells or exosomes may contain fewer or more species of target RNA molecules than the other cells or exosomes. Through the two-round encapsulation process described herein, the present method is capable of extracting single molecules from a population of cells or exosomes and analyzing target RNA molecules from each of these cells or exosomes. Both the number of cells or exosomes in the population, the number of cells or exosomes containing the target RNA, and the number of target RNA molecules from each cell or exosome can be determined using assays (e.g. ExoELISA and rt-PCR reactions) described herein.

### Example 3—Co-Detection and Quantitation of Nucleic Acids and Proteins

This example illustrates one example of using the present invention for detecting nucleic acids and proteins using the present integrated droplet microfluidic system.

In this example, a panel of protein markers and gene markers that might be used to detect many solid tumors prior to metastases is evaluated. Diagnosis based on both protein markers and gene markers generally provide a more accurate diagnosis.

A digital PCR assay is designed to simultaneously quantify and assess multiple relevant DNA mutants, or multiple regions of driver genes that are commonly mutated in a variety of cancer types. For downstream confirmation, assay for quantifying relevant cell free protein markers is designed. Droplet digital ELISA can be utilized in conjunction with the present integrated droplet microfluidic system for absolute counting of cell free proteins.

The combined results of the quantity of protein markers and gene markers will likely give a more accurate and sensitive diagnosis than using either type of the markers alone.

### Example 4—Co-Detection and Quantitation of Protein and Messenger RNA (mRNA)

This example illustrates using the present invention for the detection of proteins and mRNA.

Integrated co-detection of proteins and mRNAs from the same cell has the potential to not only reveal the correlation between these two classes of biologically important molecules, but also help understand the mechanisms of gene regulation, at both the transcriptional and translational levels.

Procedures described in Example 2 can be applied to this example for the detection and quantitation of mRNA. Procedures described in Example 3 can be applied to this example for the detection and quantification of protein using droplet digital ELISA.

### Example 5—Co-Detection and Absolute Counting of DNA, RNA and Protein in an exosome

This example illustrates using the present invention for detecting DNA, RNA and protein from a single exosome.

Exosome contains biomolecules including DNA, RNA and protein within its lumen or on its lipid membrane. These biomolecules can be extracted from an exosome isolated from a serum sample. With the present invention, absolute count of exosome with specific targets can be determined digitally using ExoELISA method, or absolute count of individual biomolecules like DNA, RNA or protein can be determined digitally using digital PCR or digital ELISA. Information about the count of these biomolecules can be coupled or pooled for analysis in the diagnosis of cancer type.

Procedures described in Example 2 can be applied to this example for the detection and quantitation of DNA and RNA from a single exosome, and procedures described in Example 3 can be applied to this example for the detection and quantification of protein using droplet digital ELISA.

### REFERENCES

1. P. Zhu and L. Wang, “Passive and active droplet generation with microfluidics: a review” Lab Chip, 2017, 17, 34-75.
2. Baret, Jean-Christophe. “Surfactants in droplet-based microfluidics.” Lab on a Chip 12.3 (2012): 422-433.
3. Liu, Chunchen, Xiaonan Xu, Bo Li, Bo Situ, Weilun Pan, Yu Hu, TaixucAn, Shuhuai Yao, and Lei Zheng. “Single-exosome-counting immunoassays for cancer diagnostics.” Nano letters (2018).
4. Matthew C. Strain, Steven M. Lada, Tiffany Luong, Steffney E. Rought, Sara Gianella, Valeri H. Terry, Celsa A. Spina, Christopher H. Woelk, and Douglas D. Richman “Highly precise measurement of HIV DNA by droplet digital PCR.” PloS one 8.4 (2013): c55943.
5. Baret, Jean-Christophe, et al. “Fluorescence-activated droplet sorting (FADS): efficient microfluidic cell sorting based on enzymatic activity.” Lab on a Chip 9.13 (2009): 1850-1858.
6. Cohen, Joshua D., et al. “Combined circulating tumor DNA and protein biomarker-based liquid biopsy for the earlier detection of pancreatic cancers.” Proceedings of the National Academy of Sciences 114.38 (2017): 10202-10207.
7. Cohen, Joshua D., et al. “Detection and localization of surgically resectable cancers with a multi-analyte blood test.” Science (2018): caar3247.
8. Xu, X., Yuan, H., Song, R., Yu, M., Chung, H. Y., Hou, Y., Shang, Y., Zhou, H. and Yao, S., 2018. “High aspect ratio induced spontaneous generation of monodisperse picolitre droplets for digital PCR”. Biomicrofluidics, 12(1), p. 014103.
9. Liu, C., Xu, X., Li, B., Situ, B., Pan, W., Hu, Y., An, T., Yao, S. and Zheng, L., 2018. “Single-exosome-counting immunoassays for cancer diagnostics”. Nano letters.
10. Cohen, Limor, and David R. Walt. “Single-molecule arrays for protein and nucleic acid analysis.” Annual Review of Analytical Chemistry 10 (2017): 345-363.
11. Abbyad, Paul, et al. “Rails and anchors: guiding and trapping droplet microreactors in two dimensions.” Lab on a Chip 11.5 (2011): 813-821.
12. Huebner, Ansgar, et al. “Static microdroplet arrays: a microfluidic device for droplet trapping, incubation and release for enzymatic and cell-based assays.” Lab on a Chip 9.5 (2009): 692-698.
13. NiveditaMajumdar, Thomas Wessel, Jeffrey Marks, ‘Digital PCR Modeling for Maximal Sensitivity, Dynamic Range and Measurement Precision’ (2015), PLOS ONE 10(3): e0118833.
14. Chen, Walter W., et al. BEAMing and droplet digital PCR analysis of mutant IDH1 mRNA in glioma patient serum and cerebrospinal fluid extracellular vesicles. Molecular Therapy-Nucleic Acids 2 (2013).
15. Li, Tianwen, et al. Plasma circular RNA profiling of patients with gastric cancer and their droplet digital RT-PCR detection. Journal of Molecular Medicine 96.1 (2018): 85-96.

1. A droplet microfluidic system comprising:
a droplet generator and a storage device comprising a droplet storage chamber being configured for containing a plurality of droplets, wherein the droplet generator and the droplet storage device are integrated structure, wherein the droplet generator is in fluidic communication with the droplet storage device; wherein the droplets is in a one-layer configuration in the droplet storage chamber.

2. The system according to claim 1, wherein the droplet storage chamber comprising:
a droplet inlet that is in fluidic communication with the droplet generator;
a droplet outlet; and the droplet storage chamber disposed between the inlet and the outlet configuring to store droplets,
wherein a height of the storage chamber gradually decreases from the inlet to the outlet, thereby achieving one-layer configuration of droplets.

3. The system according to claim 2, wherein the one-layer configuration of the droplets is achieved near the outlet.

4. The system according to claim 1, wherein a droplet screening assembly is disposed downstream of the outlet to separate or screen target droplets.

5. The system according to claim 1, wherein within the storage chamber, a height at the inlet is greater than a diameter of a droplet, and a height near the outlet is less than or equal to the diameter of the droplet.

6. The system according to claim 5, wherein the height at the inlet is more than 1 time, 2 times, 3 times, 4 times, or 10 times the diameter of the droplet.

7. The system according to claim 5, wherein the height at the outlet is one-half of, one-third of, one-fourth of, or equal to the diameter of the droplet.

8. The system according to claim 1, wherein the storage chamber comprises a cluster of micropillars for dispersing the droplets, wherein a distance between each of the droplet-dispersing micropillars near to the inlet is greater than a distance between each of the droplet-dispersing micropillars near to the outlet.

9. The system according to claim 1, wherein the storage chamber comprises a blocking structure for blocking impurities, and the blocking structure allows the droplets to pass through.

10. The system according to claim 1, wherein the storage chamber comprises first and second blocking structures for blocking impurities, and the blocking structures allow the droplets to pass through, wherein the first blocking structures are close to the inlet, and the second blocking structures are close to the outlet.

11. The system according to claim 10, wherein a distance between the first blocking structures is greater than a distance between the second blocking structures.

12. The system according to claim 1, wherein a first blank region is disposed downstream of the droplet outlet, and droplet-dispersing micropillars are not disposed inside the blank region.

13. The system according to claim 12, wherein a cluster of first droplet-dispersing micropillars is disposed downstream of the first blank region, and the droplet-dispersing micropillars comprise more than one row of droplet-dispersing micropillars, with a distance between each of dispersing micropillars in a row configured to decrease along a direction from the inlet to the outlet.

14. The system according to claim 13, wherein the distance between each of dispersing micropillars in one row is greater than a diameter of the droplet.

15. The system according to claim 13, wherein a second blank region is disposed downstream of the first droplet-dispersing micropillars, and droplet-dispersing micropillars are not disposed inside the second blank region.

16. The system according to claim 15, wherein a second droplet-dispersing micropillars are disposed downstream of the second blank region, and the dispersing micropillars comprise a plurality of rows of droplet-dispersing micropillars, with a distance between each of micropillars in a row configured to decrease along a direction from the inlet to the outlet until it is equal to or less than a diameter of the droplet.

17. The system according to claim 16, wherein a third blank region is disposed between a downstream portion of the second droplet-dispersing micropillars and the outlet, and no dispersing micropillars are disposed inside the third blank region.

18. The system according to claim 17, wherein support pillars for supporting an upper cover are disposed within the first, second and third blank regions, and these support pillars do not substantially function to disperse the droplets.

19. The system according to claim 1, wherein the storage chamber is composed of a recessed bottom and an upper cover, and one or more support pillars are disposed on the recessed bottom to support the upper cover.

20. The system according to claim 1, wherein a droplet generator is disposed upstream of the droplet inlet, and the droplet generator is selected from the group consisting of a flow focusing structure, a cross-flowing structure, a co-flowing structure, a step emulsion structure, and a microchannel emulsification structure.

21. The system according to claim 1, wherein a droplet comprise cells or other active substances.

22. The system according to claim 1, where in the droplet generator includes a plurality of inlets, each inlet is used for receiving a different reagent component, and one inlet is used for receiving a sample.

23. The system according to claim 1, wherein the droplet generator is in fluidic communication with the droplet storage device via a microfluidic channel.
